(19) United States
(12) Patent Application Publication
(10) Pub. No.: US 2003/0198767 A1
(43) Pub. Date: Oct. 23, 2003

(54) Airbags including barrier coating and method of manufacture of same

(76) Inventors: David S. Breed, Boonton Township, NJ (US); Wendell C. Johnson, Signal Hill, CA (US)

Correspondence Address: BRIAN ROFFE, ESQ, 11 SUNRISE PLAZA, SUITE 303, VALLEY STREAM, NY, 11580-6170, US

(21) Appl. No.: 10/413,318

(22) Filed: Apr. 14, 2003

Related U.S. Application Data
(60) Provisional application No. 60/374,282, filed on Apr. 19, 2002.

(51) Int. Cl. B32B 1/02

(52) U.S. Cl. 428/36.1; 156/278; 156/307.5; 156/308.4

(57) ABSTRACT

Airbag having a barrier coating containing substantially dispersed exfoliated layered silicates in an elastomeric polymer. This coating, when dry, results in an elastomeric barrier with an improved permeability characteristics, i.e., a greater increase in the reduction of permeability of the coating. The airbag is optionally made of fabric. Methods for manufacturing airbags with a barrier coating and airbag modules including an airbag with a barrier coating are also disclosed.

### CROSS REFERENCE TO RELATED APPLICATION

This application claims priority under 35 U.S.C. §119(e) of U.S. provisional patent application Ser. No. 60/374,282 filed Apr. 19, 2002, the disclosure of which is incorporated by reference herein.

### FIELD OF THE INVENTION

The present invention relates to airbags including barrier coatings which provide reductions in gas, chemical and vapor permeability, especially side curtain airbags.

The present invention also relates to methods for manufacturing airbag modules including an airbag having a barrier coating and an associated inflator.

### BACKGROUND OF THE INVENTION

Barrier coatings which prevent, or reduce, contact of a selected substrate with a gas, vapor, chemical and/or aroma have been widely described. A recent improvement in barrier coatings is described in U.S. Pat. Nos. 6,087,016 and 6,232,389, incorporated by reference herein in their entirety.

To date, barrier coatings have not been commercially applied in airbags made of fabric and in particular side curtain airbags made of fabric which is often permeable. It would thus be desirable to improve the impermeability of the fabric of the airbags.

In contrast to frontal impact driver and passenger airbags which only are required to retain the inflation gas or other fluid for typically a fraction of a second, the side curtain airbag must retain the inflation fluid for several seconds in order to offer protection for rollover events, for example. Also, the side curtain or ceiling-mounted airbag must deploy rapidly and pack into a small space.

It is disadvantageous that current polymer coatings used on such airbags are relatively thick thereby increasing the mass of the airbag making it difficult to pack into a ceiling space and delay the deployment of the airbag in an accident thereby increasing the chance that an occupant will not receive the full benefit of the airbag. As a result of these disadvantages, such coatings are not optimal for use on side curtain airbags.

Much of the leakage in side curtain airbags occurs through the seams where the front and rear panels forming the side curtain airbag are joined. This is due to the methods of joining such panels which include sewing and interweaving. Thus, although the barrier coatings of this invention will reduce the leakage through the panel surfaces, and thus reduce the cost and mass of the airbag, alternative treatments for the seam area are also desirable as described and disclosed herein.

### OBJECTS OF THE INVENTION

It is an object of the present invention to provide new and improved vehicular airbags made of fabric or other materials, such as side curtain airbags, which exhibit improved impermeability.

It is another object of the present invention to provide new and improved vehicular airbags made of fabric or other materials, such as side curtain airbags, which exhibit lower mass, easier mounting abilities and faster deployment.

Another object of this invention is to provide an airbag with sealed seams that does not use sewing or interweaving.

It is still another object of the present invention to provide new methods for manufacturing vehicular airbags made of fabric or other materials, such as side curtain airbags, which include a barrier coating designed to improve the impermeability of the airbag.

It is yet another object of the present invention to provide new and improved methods for manufacturing airbag modules for vehicles which include airbags having a barrier coating designed to improve the impermeability of the airbag.

### SUMMARY OF THE INVENTION

In accordance with one embodiment of the invention, an airbag has a coating composition which contains substantially dispersed exfoliated layered silicates in an elastomeric polymer. This coating, when dry, results in an elastomeric barrier with a high effective aspect ratio and improved permeability characteristics, i.e., a greater increase in the reduction of permeability of the coating. Drying may occur naturally over time and exposure to air or through the application of heat.

The airbag is optionally made of fabric and can take any form including those in the prior art. For example, if a side curtain airbag, then the airbag can define a series of tubular gas-receiving compartments, or another series of compartments. The side curtain airbag can be arranged in a housing mounted along the side of the vehicle, possibly entirely above the window of the vehicle or partially along the A-pillar of the vehicle.

The side curtain airbag includes opposed sections or layers of material, either several pieces of material joined together at opposed locations or a single piece of material folded over onto itself and then joined at opposed locations. Gas is directed into the compartments from a gas generator or a source of pressurized gas. Possible side curtain airbags include those disclosed in the current assignee's U.S. Pat. Nos. 5,863,068, 6,149,194 and 6,250,668 and incorporated by reference herein.

The invention is not limited to side curtain fabric airbags and other fabric airbags are also envisioned as being encompassed by the invention. Also, it is conceivable that airbags may be made of materials other than fabric and used with a barrier coating such as any of those disclosed herein and other barrier coatings which may be manufactured using the teachings of this invention or other inventions relates to barrier coatings for objects other than airbags. Thus, the invention can encompass the use of a barrier coating for an airbag, regardless of the material of the airbag and its placement on the vehicle.

In one aspect, the present invention provides a side curtain airbag comprising one or more sheets of fabric that contains air or a gas under pressure, and having on an interior or exterior surface of the fabric sheet(s) a barrier coating formed by applying to the surface a mixture comprising in a carrier liquid an elastomeric polymer, a dispersed exfoliated layered platelet filler preferably having an aspect ratio greater than about 25 and optionally at least one surfactant. The solids content of the mixture is optionally less than about 30% and the ratio of polymer to the filler is optionally between about 20:1 and about 1:1. The coating may be dried on the coated surface, wherein the dried barrier coating has the same polymer to filler ratio as in the mixture and provides an at least 5-fold greater reduction in gas, vapor, moisture or chemical permeability than a coating formed of the unfilled polymer alone.

In one preferred embodiment, the fabric is coated with a barrier coating mixture, which contains the polymer at between about 1% to about 30% in liquid form and between about 45% to about 95% by weight in the dried coating. The dispersed layered filler is present in the liquid coating mixture at between about 1% to about 10% by weight, and in the dried coating formed thereby, at between about 5% to about 55% by weight. The dried coating, in which the filler exhibits an effective aspect ratio of greater than about 25, and preferably greater than about 100, reduces the gas, vapor or chemical permeability greater than 5-fold that of the dried, unfilled polymer alone.

In another preferred embodiment, the invention provides a fabric side curtain airbag coated with a preferred barrier coating mixture which has a solids contents of between about 5% to about 15% by weight, and comprises in its dried state between about 65% to about 90% by weight of a butyl rubber latex, between about 10% to about 35% by weight of a layered filler, desirably vermiculite, and between about 0.1% to about 15% by weight of a surfactant.

In another embodiment, the invention provides a fabric side curtain airbag on a surface or at the interface of two surfaces therein a dried barrier coating formed by a barrier coating mixture comprising in a carrier liquid, an elastomeric polymer, a dispersed exfoliated layered platelet filler preferably having an aspect ratio greater than about 25 and optionally at least one surfactant, wherein the solids content of the mixture may be less than about 30% and the ratio of polymer to the filler is optionally between about 20:1 and about 1:1. When dried, the coating optionally comprises about 45% to about 95% by weight of the polymer, between about 5% to about 55% by weight the dispersed layered filler; and between about 1.0% to about 15% by weight the surfactant. The coating on the article, in which the filler exhibits an effective aspect ratio of greater than about 25, preferably greater than about 100, reduces the gas, vapor or chemical permeability of the airbag greater than 5-fold the permeability of the airbag coated with the polymer alone.

In still another embodiment, the invention provides a fabric side curtain airbag having on a surface or at the interface of two surfaces therein a dried barrier coating formed by a barrier coating mixture comprising in a carrier liquid, a butyl-containing polymer latex, a dispersed exfoliated layered vermiculite filler preferably having an aspect ratio about 1000 or greater; and optionally at least one surfactant. The solids content of the mixture may be less than about 17% and the ratio of the polymer to the filler may be between about 20:1 and about 1:1.

In a preferred embodiment, the coating mixture has a solids content of between about 5% to about 15% by weight, and forms a dried coating on the surface that comprises between about 65% to about 90% by weight the butyl-containing polymer, between about 10% to about 35% by weight the vermiculite filler, and between about 1.0% to about 15% by weight the surfactant. The coating on the inflated product in which the filler exhibits an effective aspect ratio of greater than about 25, preferably greater than about 100, reduces the gas, vapor or chemical permeability of the airbag greater than 5-fold the permeability of the article coated with the polymer alone.

In still a further embodiment, the invention provides a method for making a fabric side curtain airbag, the method involving coating a surface of the fabric airbag with, or introducing into the interface between two surfaces of the fabric airbag, an above-described barrier coating mixture.

One method for manufacturing an airbag module including an airbag in accordance with the invention entails applying to a surface of a substrate a solution comprising an elastomeric polymer and a dispersed exfoliated layered filler and causing the solution to dry to thereby form a barrier coating on the substrate, forming an airbag having an edge defining an entry opening for enabling the inflation of the airbag from the substrate having the barrier coating thereon, arranging the airbag in a housing, sealing the edge of the airbag to the housing and providing a flow communication in the housing to allow inflation fluid to pass through the entry opening into the airbag. The airbag is preferably folded in the housing. The airbag may be formed by cutting the substrate to the desired shape and size.

Another method for manufacturing an airbag module entails applying to a surface of a first substrate a solution comprising an elastomeric polymer and a dispersed exfoliated layered filler, covering the solution with a second substrate, causing the solution to dry to thereby form a barrier coating between the first and second substrates, forming an airbag having an edge defining an entry opening for enabling the inflation of the airbag from the first and second substrates having the barrier coating therebetween, arranging the airbag in a housing and sealing the edge of the airbag to the housing. Further, a flow communication is provided in the housing to allow inflation fluid to pass through the entry opening into the airbag. The airbag may be folded in the housing. The formation of the airbag may involve cutting the first and second substrates having the barrier coating therebetween.

Another method for forming an airbag, in particular a side curtain airbag or another type of airbag made of a first piece for fabric constituting a front panel of the airbag and a second piece of fabric constituting a rear panel of the airbag, entails heat or adhesive sealing the first and second pieces of fabric together over an extended seam width to form an airbag while maintaining an entry opening for passage of inflation fluid into an interior of the airbag and partitioning the airbag along partition lines into a plurality of chambers each receivable of the inflation fluid. The location of the partition lines is determined to prevent concentration of stress in the seams, e.g., by analyzing the airbag using finite element analysis. The first and second pieces of fabric may be coated with a barrier coating.

Still another method for forming an airbag in accordance with the invention comprises the steps of providing a plurality of layers of material, interweaving, heat sealing or sewing the layers together to form the airbag while maintaining an entry opening for passage of inflation fluid into an interior of the airbag and coating the airbag with a barrier coating. The airbag may be a side airbag with front and rear panel joined together over an extended seam width. As such, it is possible to partition the airbag along partition lines into a plurality of chambers each receivable of the inflation fluid and determine the location of the partition lines to prevent concentration of stress in the seams.

Other aspects and advantages of the present invention are described in the detailed description below and in the claims.

### BRIEF DESCRIPTION OF THE DRAWINGS

The following drawings are illustrative of embodiments of the invention and are not meant to limit the scope of the invention as encompassed by the claims.

FIG. 1 is a “Cussler” model graph indicating) the effective aspect ratios achieved by compositions of this invention. The graph plots reduction of permeability vs. volume percentages of filler in barrier coating mixtures of the present invention. Cussler describes several models for the permeability reduction due to oriented layered fillers, which depend on the microstructure expected. For simplicity, this invention employs the equation: Pu/P=[1+(a2X2)/(1−X)]/(1−X), where P is the permeability of the filled material, Pu is the permeability of the unfilled material; a is the aspect ratio of the filler particles; X is the volume fraction of the filler particles in the coating. Cussler's theoretical curves for fillers with aspect ratios of 25, 50, 75, and 100 are present on the graph. The thick “experimental” data line records the experimental data points for the barrier coating mixtures of Examples 1-8 below. Effective aspect ratios can be estimated from the position of the data relative to the theoretical curves.

FIG. 2 is a graph plotting permeability results based on the weight percentage of a filler, vermiculite. Permeability is plotted vs. weight % of filler. Increase in weight % of filler decreases the permeability of the coating.

FIG. 3 is a graph plotting reduction in permeability vs. weight % of filler in coating. Increase in weight % of filler increases the reduction of permeability.

FIG. 4 is a graph illustrating the maximum percentage solids useful in coating compositions of the invention using butyl latex (BL100™), vs. percentage by weight of MICROLITE® vermiculite in the compositions.

FIG. 5 is a graph illustrating the butyl latex (BL100™) to filler ratio useful in coating compositions of the invention vs. percentage by weight of MICROLITE® vermiculite in the compositions.

FIG. 6 illustrates flexibility data at 10% elongation, 1K cycles based on the flex test of Example 17.

FIG. 7 is a schematic view of a vehicle with portions cutaway showing an airbag module including an airbag in accordance with the invention in the ceiling of the vehicle.

FIG. 8 is an enlarged view of airbag module shown in FIG. 8;

FIG. 9A is a cross-sectional view taken along the line 9-9 in FIG. 8.

FIG. 9B is another cross-sectional view taken along the line 9-9 in FIG. 8.

FIG. 10 is a flow chart of a method for designing a side curtain airbag in accordance with the invention.

### DETAILED DESCRIPTION OF THE INVENTION

The present invention fills a need in the art of fabric airbags by providing fabric airbags coated with barrier coating mixtures. These coatings of the invention reduce the gas, vapor or chemical permeability of these fabric airbags. Preferably, side curtain airbags made of fabric are provided by the invention.

Improved side curtain airbags made of fabric prepared by use of these coatings demonstrate reduced permeability to air, gas, vapor and chemicals. The compositions and methods of this invention rely on the use of the barrier coating mixtures to coat various interior and exterior surfaces of the side curtain airbags to improve performance and/or lower cost.

I. Definitions

As used herein, the term “mixture” or “coating mixture” is interpreted to include true liquid solutions, as well as colloidal dispersions, suspensions, emulsions and latexes as they are conventionally defined. For example, by “colloidal dispersion or latex” is meant any dispersion or suspension of particles in liquid, the particles being of a size greater than molecular scale, e.g., about 0.001 to about 0.1 micron. An emulsion generally contains particles of about 0.05 to 1.0 microns, in liquid. A “suspension” generally contains particles of greater than 1.0 micron in liquid.

A “barrier coating mixture” as used herein is meant a liquid containing dissolved or suspended solids, which is used to apply the solids to a substrate. A novel aspect of the present invention is that the barrier coating mixtures provide a better dispersion of platelet fillers in liquid at an unusually low solids content, e.g., between about 1 to about 30% solids as described in more detail below. According to this invention, once the “coating mixture” is dried, it is referred to as a “dried coating” or a “film”. The term “vapor barrier” implies a barrier to a liquid and its vapor. Conventionally, a vapor is the gas in equilibrium with a liquid at atmospheric pressure. For simplicity, as used herein, the term “vapor barrier” can be interpreted to mean a barrier to gases and chemicals as well as traditionally defined vapors, as well as a barrier to moisture, generally water or water vapor.

The term “gas barrier” includes a barrier to oxygen, nitrogen, carbon dioxide and other gases. “Chemical barrier” includes a barrier to the migration or blooming of a molecule from one substrate to another or out of one substrate to that substrate's surface.

The term “aspect ratio” is a characteristic of every platelet material in solid form. Aspect ratio is a lateral dimension of a platelet filler particle, e.g., mica flake, divided by the thickness of the platelet. “High aspect ratio” refers to a platelet filler whose lateral dimension divided by thickness is greater than 25. The aspect ratio of any filler is an inherent property of the selected filler. For example, MICROLITE® 963++ aqueous vermiculite solution [W. R. Grace] has a characteristic aspect ratio of about 10,000 or dimensions of 10-30 μm×10 Å.

Intercalation is defined as the state of a coating composition in which polymer is present between each layer of a platelet filler. Intercalation can be defined by the detection of an X-ray line, indicating a larger spacing between vermiculite layers than in the original mineral. “Exfoliation” is defined for layered fillers as the complete separation of individual layers of the original particle, so that polymer completely surrounds each particle. Desirably so much polymer is present between each platelet, that the platelets are randomly spaced. No X-ray line appears because of the random spacing of exfoliated platelets. In some circumstances, the filler can exfoliate when dispersed in an aqueous or non-aqueous medium. This would result in a higher aspect ratio than that of a solid particle before dispersion.

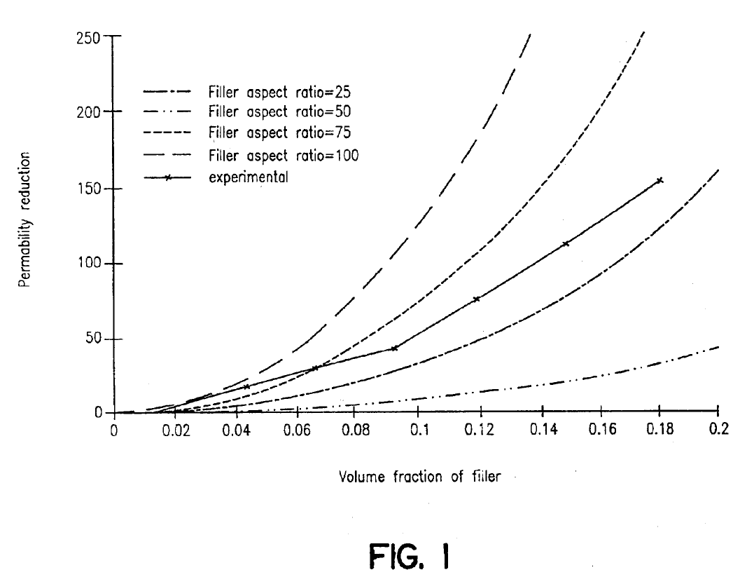

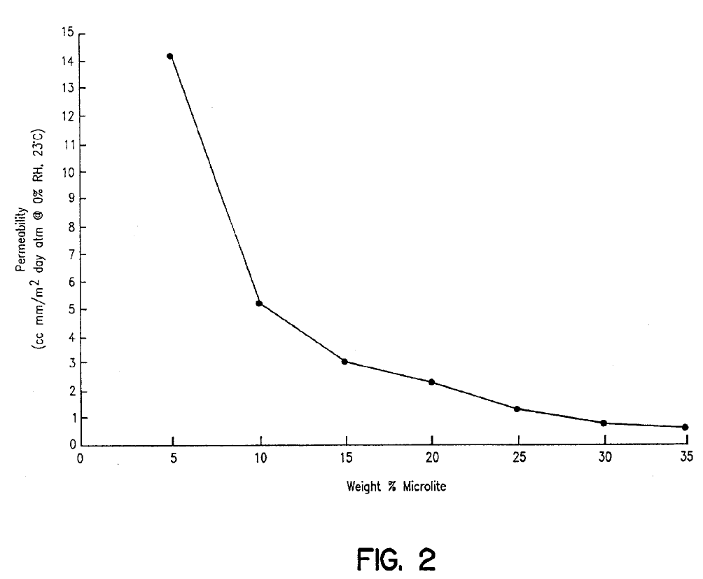

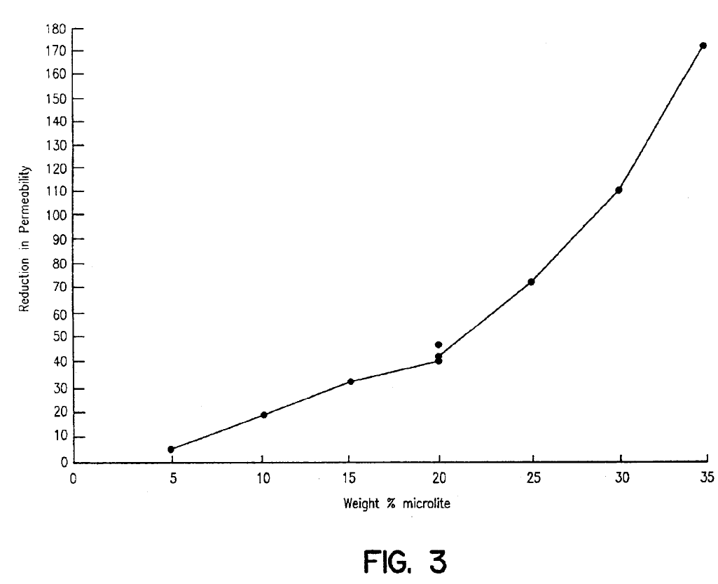

The term “effective aspect ratio” relates to the behavior of the platelet filler when incorporated into a binder. The platelet may not exist in a single platelet formation, but in many forms, such as a bundle of 10-50 platelets or hundreds of platelets, referred to as agglomerates. If the platelets are not in the single layer form, the aspect ratio of the entire bundle or agglomerate is much lower than that of the single layer particle. Therefore, the aspect ratio of the particles in a binder is referred to as an effective aspect ratio. The effective aspect ratio is determined by plotting the experimental data versus theoretical model, such as described by E. L. Cussler et al, J. Membrane Sci., 38:161-174 (1988). A graph of reduction in permeability versus the volume % of filler in the binder generates theoretical curves for each effective aspect ratio. The graph predicts an effective aspect ratio for the experimental data (see FIG. 1).

It is important in the understanding of the effects of the coatings of this invention to differentiate between “effective aspect ratio” and “aspect ratio”. The aspect ratio is characteristic of a platelet material in the solid form or one platelet and can be determined by light scattering techniques or microscopy. The term “effective aspect ratio” is much different in that it relates to the behavior of the platelet when incorporated into a binder. It may no longer be a single platelet but instead bundles of platelets referred to as agglomerates. This value is determined using experimental permeability data plotted versus theoretical behavior of the platelet. For example, experimental data when plotted versus the theoretical model of the platelet in the binder [see E. L. Cussler et al, J. Membrane S., 38:161-174 (1988)] is directly related to the barrier improvement of the coating through Cussler's theoretical model. Most commercially available fillers have aspect ratios ranging from 25 up to 10,000. However, the effective aspect ratio of these fillers when incorporated into a binder is much lower when incorporated into a binder and is directly related to the barrier improvement due to the platelet filler, generally resulting in reduced barrier properties. It is important to distinguish between these terms for barrier coatings containing platelet fillers.

Much of the following disclosure involving particular barrier coatings has been copied from U.S. Pat. Nos. 6,087,016 and 6,232,389. However, the invention is not limited to airbags including the barrier coatings described in these patents and encompasses airbags including any comparable barrier coatings and any barrier coatings encompassed by the claims.

II. The Barrier Coating Mixtures

A barrier coating mixture according to this invention includes the following components in a carrier liquid (i.e., aqueous or solvent):

(a) an elastomeric polymer;

(b) a dispersed, exfoliated layered platelet filler having an aspect ratio greater than 25; and

(c) at least one optional surfactant, wherein the solids content is desirably below 30% solids and the ratio of polymer (a) to filler (b) is between about 20:1 and 1:1. These barrier coating mixtures result in films with reductions in permeability of 5 times to 2300 times relative to the unfilled polymer. These results are substantially higher than the prior art on other platelet filled barrier coatings.

The barrier coating mixtures used in the invention are selected by balancing several critical features, i.e., appropriate dispersion of the filler in the elastomeric polymer, orientation of the filler platelets in the elastomeric polymer, as well as high aspect ratio of the filler, in order to achieve the desired permeability reductions and flexibility in the dried barrier coating and in the airbags. These characteristics are demonstrated by the data shown in FIG. 1. The barrier coating mixture of this invention desirably contains an unusually low solids content, i.e., between about 1% and about 30% solids. A more desirable range of solids content is between about 5% to about 17% solids.

The solids content is an important consideration in the barrier coatings compositions and performance of the dried coatings because the solids content effects the dispersion of the high aspect ratio filler. If high total solids content is used in the barrier coating composition, one would not achieve well-dispersed filler, e.g., vermiculite, and the permeability reductions characteristic of the coatings of this invention, and reported in the examples and figures herein, are not achieved. The preferred range of solid content (5%-17%) is unexpectedly well below that typically used in the coating industry and therefore not predicted by the prior art teachings concerning barrier coatings formulations. This is especially true of the airbag industry where no such fillers are used prior to the teachings of this invention.

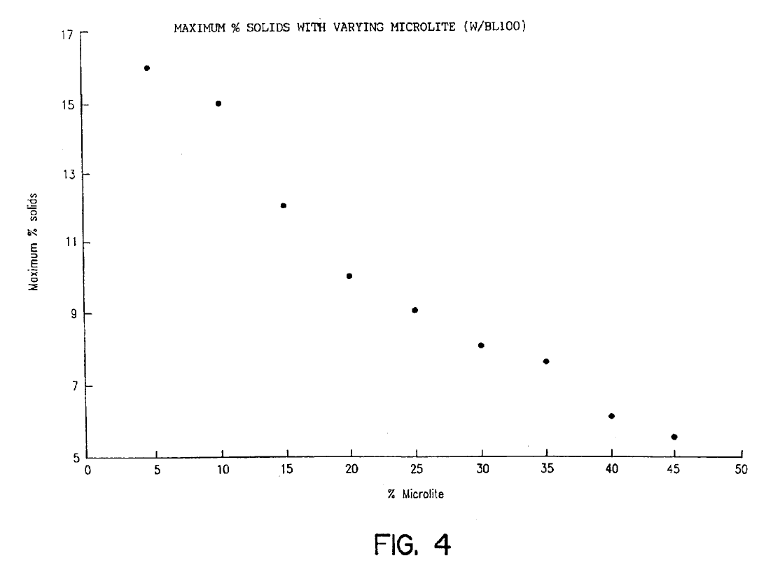

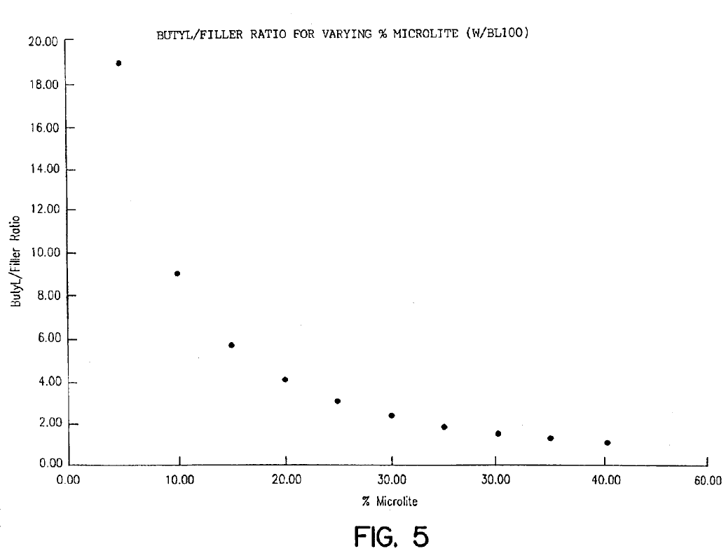

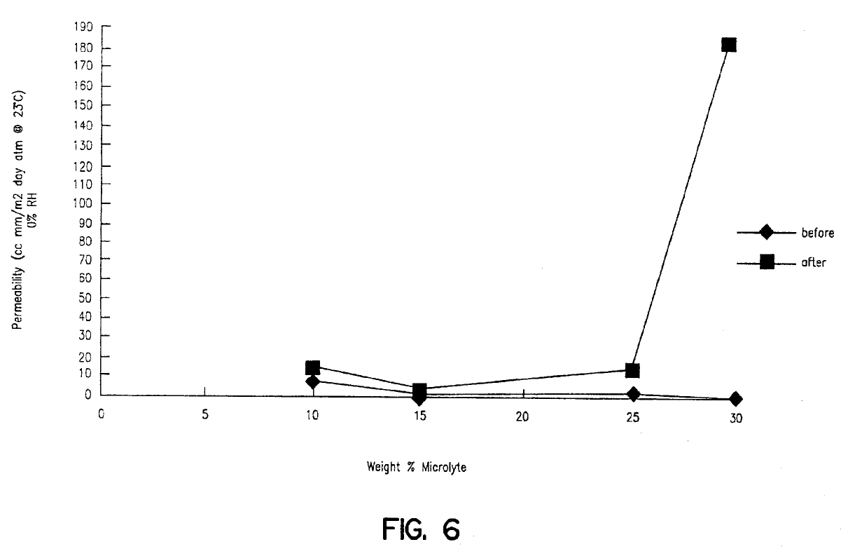

The relationship between the percentage of solids in the coating composition to the weight percent of filler in the resulting dried coating is an unexpectedly important issue in obtaining desired barrier coatings of this invention. For example, in embodiments in which the barrier coating composition contains as the elastomeric polymer, butyl rubber (Lord Corporation), and as the filler, MICROLITE® 963++ vermiculite solution (W. R. Grace & Co.), FIG. 4 illustrates a range of maximum total solids that can be used in the coatings formulation of this invention without resulting in agglomeration and other negative effects on the dried coating (i.e., film) properties as a function of the fraction of the total solids made up by the filler.

In one embodiment, where the MICROLITE® filler is at 5%, the maximum solids is about 16%; in another wherein the filler is 25%, the maximum solids is about 9%. In still another embodiment, where the filler is about 50%, the maximum solids is about 5%. Other examples fall within those ranges, as indicated in FIG. 4. The results shown in FIG. 4 are based on the formulations used in Examples 9-12.

The unusually low solids contents described in FIG. 4 for a butyl-containing polymer latex are also applicable to other elastomeric polymer latexes, as well as to elastomeric polymers in carrier liquids which also contain other solvents or co-solvents. One of skill in the art will understand the need to make some alterations in the maximums provided by FIG. 4 for other formulations of barrier coatings of this invention taking into account changes in electrolyte concentration, surfactants, grade and composition of vermiculite or other filler, and grade and composition of polymeric latex or other elastomeric polymer in a carrier as described herein.

If desired, the solids content of the barrier coating mixtures can be further adjusted to levels below the maximums shown in FIG. 4 using thickeners, in order to adjust the final film thickness, as well as to adjust the suspension rheology. See, for example, Examples 14-15 which demonstrate the increase in viscosity from 4.5 cP to 370 cP using PVOH terpolymer; and Example 16 which similarly increases viscosity using lithium chloride as a thickener. Other conventionally used thickeners may also be useful.

The solids content of the coating mixtures of this invention is preferably based upon a preferred polymer to filler ratio of between about 20:1 to about 1:1, more preferably 9:1 to 1:1, particularly when the polymer is a butyl-containing polymer such as a butyl latex, and the filler is a vermiculite solution. Examples 9-12 indicate a variety of desirable compositions of this invention characterized by a polymer to filler ratios within the above range, over a range of solids contents, polymer contents by weight and filler contents by weight.

Preferably, in the dried barrier coating (film), the polymer is present at between about 45 to about 95 by weight and the dispersed layered filler is present at between about 5 to about 55% by weight.

A. The Elastomeric Polymer

Elastomeric polymers useful in forming coating mixtures of this invention include polymers selected generally from among many classes. The selected polymers may be curable polymers, partially cured polymers, or uncured polymers, and may be soluble in water or a solvent. Such polymers include, without limitation, olefinic thermoplastic elastomer (TPO); polyamide thermoplastic elastomer (Polyamide TPE); polybutadiene thermoplastic elastomer, e.g., syndiotactic 1,2-polybutadiene thermoplastic elastomer (polybutadiene TPE); polyester thermoplastic elastomer (Polyester TPE); polyurethane thermoplastic elastomer (TUPR), for example, thermoplastic polyester-polyurethane elastomer (TPAU), and thermoplastic polyether-polyurethane elastomer (TPEU); styrenic thermoplastic elastomer (Styrenic TPE); vinyl thermoplastic elastomer, e.g., polyvinyl chloride polyol (pPVC).

A variety of rubbery polymers (curable, partially cured, or uncured) may also be employed as the polymer component of the present invention, including acrylic rubber, such as ethylene-acrylate copolymer (EACM); and butadiene rubber, such as polybutadiene. Butyl-containing polymers useful in forming coating mixtures of this invention include, without limitation, curable, partially cured, or uncured polymers: butyl rubber, such as isobutylene-isoprene copolymer (IIR); bromobutyl rubber, e.g., bromoisobutylene-isoprene copolymer (BIIR); chlorobutyl rubber, e.g., chloroisobutylene-isoprene copolymer (CIIR); and isobutylene rubber. Butyl rubber is defined as a poly(isobutylene) homopolymer or a copolymer of poly(isobutylene) with isoprene. Modified butyl rubbers include halogenated poly(isobutylene) and its copolymers and isoprene. Additional polymers or copolymers that contain more than 50% isobutylene are also useful in the practice of this invention, for example, poly(isobutylene-co-acrylonitrile), etc. Other butyl-containing polymers which are curable, partially cured or uncured, may be readily selected by one of skill in the art.

Still other useful elastomeric polymers are chlorosulfonated polyethylene rubber, e.g., chlorosulfonated polyethylene (CSM)-; epichlorohydrin rubber, such as polyepichlorohydrin (CO), polyepichlorohydrin copolymer (CO copolymer); ethylene-propylene rubber (EPR), such as ethylene-propylene copolymer (EPM), ethylene-propylene-diene copolymer (EPDM).

Other polymers for such use include fluoroelastomers, such as vinylidene fluoride-hexafluoropropylene copolymer (FKM); natural rubber (NR); neoprene rubber such as polychloroprene (CR); nitrile rubber, such as acrylonitrile-butadiene copolymer (NBR); polyisoprene rubber (PI); polysulfide rubber; polyurethane, such as polyester urethane (AU), and polyether urethane (EU); propylene oxide rubber; silicone rubber, such as silicone (MQ), and methylvinyl-fluorosilicone (FVMQ) and styrene-butadiene rubber, such as styrene-butadiene copolymer (SBR).

The polymer is preferably capable of forming a solution, dispersion, latex, suspension or emulsion in water or a solvent, or a mixture thereof. Specifically exemplified below is a coating mixture of the invention employing as the elastomeric polymer, butyl latex. A suitable commercially available butyl latex for use in the compositions of this invention is Lord® BL-100 butyl latex, which is a 62% by weight aqueous butyl latex solution [Lord Corporation]. Another suitable butyl latex, the use of which is illustrated in Example 10, is Polymer Latex ELR butyl latex, a 50% butyl latex solution (Polymer Latex). Still another suitable polymer is a 51.7% bromo-butyl latex solution available from Polymer Latex (see Examples 11-12). These latexes contain an ionic surfactant package which stabilizes the latex and effects the performance of the barrier formulation. Other butyl latexes are anticipated to be similarly useful if combined with similar ionic surfactants. Preferably, the selected polymer is present in the dried coating mixture at a minimum of about 45% by weight of the dried compositions.

B. The Filler

The coating mixtures of this invention as described above also include a dispersed layered filler which, upon mixture, has an inherently high aspect ratio, which can range from about 25 to as high as about 30,000. The presently preferred filler is vermiculite. More particularly, a desirable vermiculite is MICROLITE® 963++ water-based vermiculite dispersion (W. R. Grace) [see, EP Application No. 601,877, published Jun. 15, 1994]which is a 7.5% by weight aqueous solution of dispersed mica. One novel aspect of the mixtures of the present invention is the effective aspect ratio of the selected filler in the dried coating. According to this invention, in the dried coating, the filler remains substantially dispersed, thereby having a “high effective aspect ratio”, as shown in FIG. 1. FIG. 1 assumes high levels of orientation.

Preferably, the effective aspect ratio of the filler in the compositions of this invention is greater than 25 and preferably greater than about 100, although higher ratios may also be obtained. In embodiments in which orientation is not high, the effective aspect ratio required for large reductions in permeability will be higher than 100. In the coating mixtures (the liquid), the layered filler is present at between about 1 to about 10% by weight of the total mixture. In the dried coatings of this invention, the layered filler is present at a minimum of about 5% by weight to a maximum of about 55% of the dried coating. The compositions of the present invention, when dried, retain the filler in well-dispersed form, resulting in a high effective aspect ratio of the dried coating, and greatly increased reduction in permeability, as illustrated in FIG. 1.

MICROLITE® vermiculite is the preferred filler because of its very high aspect ratio. The vermiculite plates have an average lateral size of between 10 and 30 microns. The plates are largely exfoliated in water, and thus their thickness is 1-2 nm. The aspect ratio of the filler in water dispersion is an average of 10,000-30,000. It is clear that many plates reassemble during the coating and drying process of the present invention, thus reducing the effective aspect ratio achieved in the final coating. However, it is a great advantage to start with as large an aspect ratio as possible.

Although MICROLITE® 963++ vermiculite (W. R. Grace) is preferred, good results may also be achieved with less exfoliated grades of MICROLITE® vermiculite (i.e., grades 963, 923, and 903). Other layered silicates are also useful in the barrier coatings and films of this invention. The effectiveness of other silicates in the barrier coating of this invention depends upon the lateral size of the platelets, the degree of exfoliation in water, and the degree to which they reassemble to form larger particles during the coating and drying process. Examples of other layered silicates include bentonite, vermiculite, montmorillonite, nontronite, beidellite, volkonskoite, hectorite, saponite, laponite, sauconite, magadiite, kenyaite, ledikite and mixtures of the above silicates. The selection and use of other known silicates which have properties similar to those of MICROLITE® vermiculite, as well as sufficiently high aspect ratios, are expected to be obvious to one of skill in the art following the teachings of this invention.

C. Surfactants and Other Additives

Coating mixtures used in the invention, particularly those useful on surfaces and interfaces according to this invention, also preferably contain at least one or more suitable surfactant to reduce surface tension. Surfactants include materials otherwise known as wetting agents, anti-foaming agents, emulsifiers, dispersing agents, leveling agents etc. Surfactants can be anionic, cationic and nonionic, and many surfactants of each type are available commercially. A suitable surfactant for inclusion in these compositions possesses a critical micelle concentration sufficiently low to ensure a dried coating uncompromised by residual surfactant.

Preferably, the surfactant(s) useful in the methods and solutions of this invention are nonionic, particularly useful with a highly charged filler, such as vermiculite. In the event of an unfavorable interaction of the anionic emulsifier present in the butyl latex dispersion [Lord], which is a presently preferred source of the butyl-containing polymer, any additional ionic additives must be kept to a minimum. This variable is eliminated where the surfactant or emulsifier is non-ionic. Increase in ionic concentration of the compositions containing vermiculite, such as by the addition of a base to adjust pH, e.g., LiOH, NH₄OH, and NaOH can cause agglomeration of the filler, which adversely affects permeability reduction.

Some embodiments of this invention include at least two surfactants, which include preferably both a wetting agent and an anti-foaming agent. Still other compositions may have additional surfactants to perform additional effects. Desirable surfactants employed in the examples below are the non-ionic siloxane-based, Silwet® L-77 wetting agent [OSI Specialties, Inc.], the BYK®-306 wetting/leveling agent [BYK Chemie], FOAMASTER® VL defoamer (Henkel), and the DC200® anti-foaming agent [Dow Corning], among others. As exemplified below, an antifoaming agent may be predispersed in solution with, e.g., 1-methyl-2-pyrrolidinone (NMP) because some antifoaming agents are not soluble in the barrier coating.

Other suitable surfactants may also be selected. The amount and number of surfactants added to the coating solution or composition will depend on the particular surfactant(s) selected, but should be limited to the minimum amount of surfactant that is necessary to achieve wetting of the substrate while not compromising the performance of the dried coating. For example, typical surfactant amounts can be less than or equal to about 10% by weight of the dried coating.

In another embodiment, thickeners may be used in the coating formulations to adjust viscosity. Such thickeners may include, without limitation, a polyvinyl alcohol (PVOH) terpolymer, e.g., polyvinylbutyral/polyvinylacetate/polyvinylalcohol or a lithium chloride thickener. In one embodiment, the viscosity of the coating mixture can be increased from 4.5 cP to 370 cP with the addition of the PVOH terpolymer to the formulation as illustrated in Examples 14-15. For example, for a coating mixture containing 10% total solids with 2% MICROLITE® vermiculite formulation, a thickener such as PVOH terpolymer can be added in an amount of between about 3% to about 5.5% by weight. Desirably the thickener is added in an amount of greater than 3.5% by weight. A preferred range of thickener is between about 5 and 5.5% by weight.

It has been noted that greater than 5.5% by weight of PVOH terpolymer thickener can cause agglomeration of the filler platelets. As another example, the viscosity of the coating mixture can also be increased with the addition of lithium chloride as a thickener to the coating mixture, (See e.g., Example 16). For example, for a coating mixture containing 10% total solids with 2% MICROLITE®, the thickener is employed in an amount between about 3% to about 5% by weight. Desirably greater than 4% thickener is employed, and more desirably 5% thickener is employed. Greater than 5% by weight of the lithium chloride thickener produces poor barrier properties. One of skill in the art would readily determine and adjust the type and amounts of thickener depending on the type and amount of filler employed in the coating mixture based on the teachings contained herein.

Still other optional components of the barrier coating are components which effect curing of the coating. For example, one type of cure “package” contains about 10 to about 30% by weight zinc oxide, about 5 to about 20% by weight sulfur, about 30 to about 60% by weight water, about 0.1 to about 10% of a dispersing agent, about 5 to about 20% of zinc dibutyldithio-carbamate and about 1 to about 10% zinc 2-mercaptobenzothiazole. The amount of cure package added to the coating mixture is based on the amount of butyl rubber in the coating mixture.

In one embodiment, greater than 10 parts dried cure package is added per 100 parts butyl rubber in the coating mixture. A desirable amount of dried cure package is about 15 parts cure package per 100 parts butyl rubber in the mixture. One of skill in the art can readily design a cure “package” to enhance the curing of a butyl latex barrier coating mixture of this invention, and select a desirable amount to be added to the coating mixture, based on the teachings of this specification combined with the knowledge of the art. See, e.g., U.S. Pat. No. 4,344,859.

D. The Carrier Liquid

The coating mixtures of this invention are present in a suitable carrier liquid. Carriers which are suitable for use in the composition of this invention include, without limitation, water and solvents such as hexane, heptane, toluene, 1 methyl-2-pyrrolidinone, cyclohexanone, ethanol, methanol, and other hydrocarbons. Combinations of water with an organic carrier may also be used as the carrier liquid. Selection of a suitable organic solvent carrier is within the skill of the art.

E. Specific Embodiments of Barrier Mixtures

One example of a barrier coating mixture useful for application to substrates such as a fabric portion of an airbag and in particular a side curtain airbag according to this invention comprises coating formed by a barrier coating mixture comprising in a carrier liquid: (a) an elastomeric polymer; (b) a dispersed exfoliated layered platelet filler preferably having an aspect ratio greater than 25; and optionally (c) at least one surfactant. The elements are selected so that the solids content of the mixture is less than about 30% and the ratio of the polymer to the filler is preferably between about 20:1 and about 1:1. These barrier coating mixtures result in films with reductions in permeability of 5 times to 2300 times relative to the unfilled polymer. These results are substantially higher than the prior art on other platelet filled barrier coatings or any airbag coatings.

Another barrier coating mixture which is desirable for application to a fabric portion of an airbag according to this invention includes the following components in a carrier liquid, (a) a butyl-containing polymer latex; (b) a dispersed exfoliated layered vermiculite filler preferably having an aspect ratio about 1000 or greater; and optionally (c) at least one surfactant. The components are selected such that the solids content of the mixture is less than abut 17% and the ratio of the polymer to the filler is between about 20:1 and about 1:1.

In a preferred embodiment, the coating mixtures described above have solids contents of between about 5% to about 15% by weight, and form dried coatings on the airbag surface that comprise between about 45% to about 95% by weight of the polymer, between about 5% to about 55% by weight of the filler, and between about 1.0% to about 10% by weight of the surfactant(s). The dried coatings of the mixtures described above, contain fillers which preferably exhibit an effective aspect ratio of greater than about 25, reduces the gas, vapor or chemical permeability greater than 5-fold that of the dried, unfilled polymer alone. Preferably, the effective aspect ratio of the dried coatings is greater than about 50, and even greater than about 100.

One preferred coating mixture useful in this invention has a solids contents of between about 5% to about 15% by weight and the dried coating comprises between about 65% to about 90% by weight of a butyl-containing polymer latex, between about 10% to about 35% by weight of a vermiculite filler, between about 0.1% to about 0.10% by weight an anti-foaming agent as surfactant, with the total surfactant weight percent up to about 15%. As described in examples below, the selected polymer is the elastomer butyl rubber or butyl latex, e.g., Lords BL-100 butyl latex in a 62% by weight aqueous butyl latex solution [Lord Corporation]. Additional preferred barrier coating mixtures useful in this invention may be prepared by methods described in detail in Examples 1-12 and 14-16.

III. The Coated Article

Once prepared as described in detail in the Examples below, the coating mixtures may be applied to a portion of fabric which will be incorporated into or sewn to form an airbag of a vehicle, to reduce the permeability of the fabric to gas, vapor (moisture) or chemicals. The dried coating, in which the filler exhibits an effective aspect ratio of greater than about 25, reduces the gas, vapor or chemical permeability greater than 5-fold that of the dried, unfilled polymer alone. In the dried coating, more preferably, the polymer is present in the mixture when dried at a weight percent of at least about 45%. The filler is preferably present in the mixture when dried at greater than about 5% by weight. These barrier films achieve reductions in permeability of 5 times to 2300 times relative to the unfilled polymer. These results are substantially higher than the prior art on other platelet filled elastomers.

Preferably, the effective aspect ratio of the dried coating is greater than about 50, and even greater than about 100. As indicated in Examples 1-12, reductions in permeability attributed to compositions of this invention can range from approximately 5 times to 2300 times that of unfilled polymer alone.

The coating compositions used in the invention may be applied on the inside of the fabric, i.e., on a portion of the fabric which, once the airbag is formed, will face the interior gas-receiving compartment of the airbag. The coating is applied by standard techniques, with spray coating and dip coating likely to be the most effective.

The present invention substantially reduces the weight of a side curtain airbag, for example, by providing equivalent sealing of the fabric thereby reducing the flow of the inflation gas through the material using substantially less sealing material. Typically, the weight of the sealant is reduced by a factor of five or more. However, much of the leakage occurs through the seams and sealing the fabric will not reduce this leakage. Most side curtain airbags are currently sealed at the edges by sewing or interweaving where the entire airbag is woven at once. In the first case, the sewing threads make holes in the fabric and serve as a path for gas leakage. In the second case, interweaving results in a leakage path since when the airbag is pressurized the stresses in the seams separate the threads at the joints again creating leakage paths. A preferred method is to heat or adhesive seal the pieces of fabric together and to do so over an extended seam width thereby eliminating the leakage paths. Since such seals are often weaker than a sewn or woven seam, careful attention must be given to the design of the airbag chambers to prevent stress concentrations in the seams. This frequently requires a finite analysis and redesign of the individual chambers in order to eliminate such stress concentrations.

The airbag may be formed completely by interweaving, heat sealing or sewing of the layers before the barrier coating is applied. Currently, airbags are often formed this way but without a barrier coating. In general, any known technique for manufacturing an airbag can be applied to make an airbag in accordance with the invention, i.e., an airbag made of one or more substrates and a barrier coating.

A selected barrier coating mixture, such as those described above may be applied to a surface or interface of a fabric section to be incorporated into an airbag to accomplish a variety of purposes in the airbag manufacturing industries to reduce the permeability of the airbag to gas, vapor or chemicals.

IV. Methods of Coating a Substrate or Forming a Film

The fabric sections to be coated by the compositions of the invention may be previously untreated or may have a variety of pre-treatments to their surfaces. For example, the fabric sections may have on at least one side a heat seal layer. Such heat seal layers may be made of an ethylene-propylene copolymer or ethylene-propylene-butylene terpolymer. Thus, the coating solution is applied on the surface of the heat seal layer. Alternatively, the fabric sections may comprise a protective topcoat layer, such as polyurethane or Teflon-type materials [DuPont] for abrasion resistance, etc. Such topcoats may be selected by one of skill in the art. The coatings of this invention may be applied over or under the topcoat layer.

Alternatively, the article may be cured prior to application of the coating, or it may be cured following application of the coating on the appropriate surface.

To form the coated article of this invention, the application of the selected barrier coating mixture may be accomplished by techniques including, without limitation, roller transfer or paint coating, spray coating, brush coating and dip coating. Roll coating techniques include, but are not limited to, rod, reverse roll, forward roll, air knife, knife over roll, blade, gravure and slot die coating methods. General descriptions of these types of coating methods may be found in texts, such as Modern Coating and Drying Techniques, (E. Cohen and E. Gutoff, eds; VCH Publishers) New York (1992) and Web Processing and Converting Technology and Equipment, (D. Satas, ed; Van Nostrand Reinhold) New York (1984). Three dimensional articles may preferably be coated by the techniques which include, but are not limited to, spray coating or dip coating. The method of application is not a limitation on the present invention, but may be selected from among these and other well-known methods by the person of skill in the art. However, the coating must be applied so that drying takes place on the substrate and not in the air (i.e. powder coating). If drying takes place during spraying or other means of application, agglomeration may occur.

The coating mixtures may be applied to a fabric substrate, such as an exterior or interior surface, an interface, or component of the airbag, at any desired thickness. Thus, for example, the coating mixtures of the present invention may be applied to the surface of fabric sections by the methods described above to form a dried coating of a thickness between about 0.11 μm to about 100 μm of dry coating. Such adjustments to thickness are well within the skill of the art [see, e.g., Canadian Patent No. 993,738].

After coating, the coated airbag, may be dried at a selected temperature, e.g., room temperature or greater than room temperature. The selection of the drying temperature, relative humidity, and convective air flow rates depends on the desired time for drying; that is, reduced drying times may be achieved at elevated air temperatures, lower relative humidity and higher rates of air circulation over the drying coating surface. After drying, the exfoliated silicate filler particles are oriented within the elastomeric latex (solution, emulsion, etc.) to a high degree parallel to each other and to the airbag substrate surface. One of skill in the art can readily adjust the drying conditions as desired. The performance of the dried barrier coating is insensitive to drying temperatures over the range 25-160° C.

The dried coatings exhibit a surprising reduction in permeability compared to the prior art and particularly compared to unfilled polymers.

The dried coating preferably maintains its low permeability after repeated mechanical loading and elongation up to about 10% of the airbag. The evaluation of the coating integrity after exposure to repeated loading and elongation was examined as described below in Example 17.

The coatings and methods of the present invention described above may be applied to the manufacture or repair of airbags to improve air or gas retention. The barrier coatings may allow reduced mass, reduced gas permeability resulting in better air retention, reduced thermo-oxidative degradation, and enhanced wear and elongation of the useful life of the article.

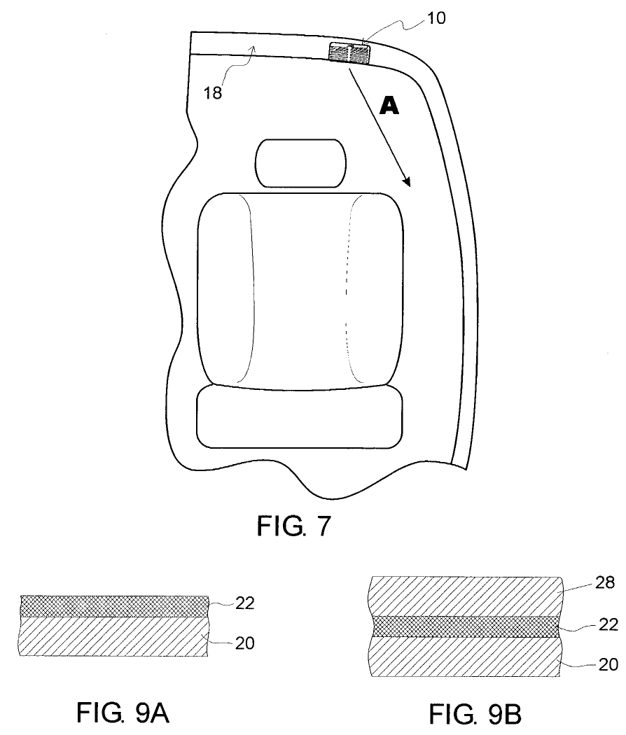

Referring now to FIGS. 7, 8, 9A and 9B, an airbag module in accordance with the invention is designated generally as 10 and comprises a module housing 12 in which an airbag 14 is folded. The housing 12 may be arranged in any vehicle structure and includes a deployment door 16 to enable the airbag to deploy to protect the occupants of the vehicle from injury. Thus, as shown, the housing 12 may be mounted in the ceiling 18 of the vehicle passenger compartment 20 to deploy downward in the direction of arrow A as a side curtain airbag to protect the occupants during the crash.

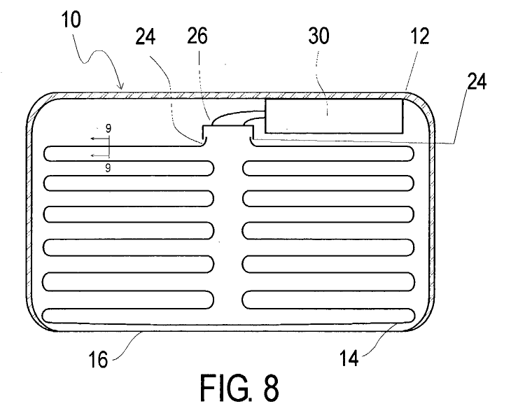

As shown in FIG. 9A, one embodiment of the airbag 14 comprises a substrate 20 and a barrier coating 22 formed on the substrate 20, either on the inner surface which will come into contact with the inflation fluid or on an outer surface so that the barrier coating will come into contact only with inflation fluid passing through the substrate 20. The airbag 14 may be formed with any of the barrier coatings described herein. In one embodiment, a flat sheet of the substrate 20 would be coated with the barrier coating 22 and then cut to form airbags having an edge defining an entry opening for enabling the inflation of the airbag. The edge 24 of the airbag 14 would then be connected, e.g., by sealing, to a part 26 of the housing 12 which defines a passage through which the inflation fluid can flow into the interior of the airbag 14 (see FIG. 8). The inflation fluid may be generated by an inflator 30 possibly arranged in the module housing 12.

In the embodiment shown in FIG. 9B, the barrier coating 22 is placed between two substrates 20,28. Any number of substrates and barrier coatings can be used in the invention. Also, the number of substrates and barrier coatings can be varied within a single airbag to provide additional substrates and/or barrier coatings for high stresses areas.

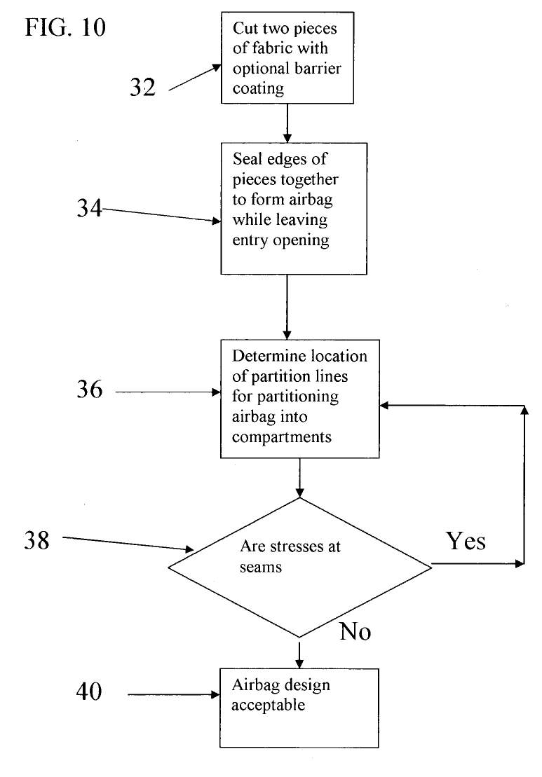

Referring now to FIG. 10, a method for designing a side curtain airbag in accordance with the invention will now be described. It is a problem with side curtain airbags that since they are usually formed of two pieces of material, the manner of connecting the pieces of material results in leakage at the seams.

To avoid this problem, in the invention, two pieces of material, for example, a piece of fabric with a barrier coating as described herein, are cut (step 32) and edges of the two pieces are sealed together to form an airbag while leaving open an entry opening for inflation fluid (step 34). The location of partition lines for partitioning the airbag into a plurality of compartments, e.g., a plurality of parallel compartment each of which is receivable of inflation fluid and adapted to extend when inflated vertically along the side of the vehicle, is determined (step 36) and it is determined whether the stresses are at the seams (step 38). If not, the design is acceptable (step 40). Otherwise, the airbag is redesigned until stresses arc not created at the seams during inflation or a minimum of stress is created at the seams during inflation. The determination of the location of the partition lines may involve analysis of the airbag using finite element theory.

The invention is illustrated by the following examples, which are not intended to limit the scope of this invention.

### EXAMPLE 1

Barrier Coating

An aqueous elastomeric barrier coating solution according to this invention is prepared as follows, in which the elastomer is butyl latex (MW=600,000) and the filler is MICROLITE® dispersed mica.

In a 50 mL beaker, 0.7 g BYK®-306 wetting agent (a polyether modified dimethyl polysiloxane copolymer) [BYK Chemie], 4.4 g 1N NH₄OH and 20.5 g distilled water are stirred into solution on a stir plate with a stir bar. 18.9 g Lord® BL-100 butyl latex in a 62% by weight aqueous butyl latex solution [Lord Corporation] is placed in a glass jar, and the solution is slowly added to the butyl latex with stirring. The resulting solution is Solution A.

In a 10 mL beaker, a premix to disperse the antifoaming agent in a water soluble solvent is made by mixing 0.125 g of solvent 0.04% by weight 1-methyl-2-pyrrolidinone (NMP) solution and DC 200 Fluid®, 1000 cs [Dow Corning] and 1.5 g 1N NH₄OH. This solution is added with stirring with a stir bar on a stir plate to a separate 100 mL beaker containing 17.3 g MICROLITE® 963++ dispersed mica in a 7.5% by weight aqueous solution [W. R. Grace]. Distilled water (36.3 g) is added to the resulting solution, which is referred to as Solution B.

Solution B is slowly added into stirred Solution A with maximum stirring on the stir plate. High shear stirring is not used. The resulting dispersion at room temperature is ready for application, e.g., spray-coating, onto a plastic or rubber substrate. The coating mixture has a 13.7% solids in water content.

After this coating solution is applied to a polypropylene film substrate and allowed to dry, the coating contains 85.4% by weight butyl rubber, 9.5% by weight filler, 5.1% BYK wetting agent, and 0.0003% by weight DC200 anti-foaming agent (a linear polydimethylsiloxane polymer) [Dow Corning].

The oxygen transmission rate (OTR) is measured using a MOCON® OX-TRAN 2/20 module. The OTR is 239.6 cc/m² day @ 1 atmosphere, 0% RH, 23° C. Permeability of the composition is 5.2 cc mm/m² day atmosphere @ 0% RH, 23° C. The reduction in permeability of this coating is 18.1 times the reduction in permeability of the unfilled butyl latex.

### EXAMPLE 2

Barrier Coating

Another aqueous elastomeric barrier coating solution according to this invention is prepared as follows, in which the elastomer is butyl latex (MNW=600,000) and the filler is MICROLITE® dispersed mica at 5% by weight.

In a 50 mL beaker, 0.5 g BYK® (BYK Chemie), 5.3 g 1N NH₄OH and 16 g distilled water are weighed and mixed and the resulting solution stirred on a stir plate with a stir bar. In a 2 oz glass jar, 23 g of Lord® BL-100 Butyl Latex (62% butyl latex solution, Lord Corporation) is weighed. Slowly the solution in the 50 mL beaker is added into the butyl latex solution while manually stirring. This is Solution A, which is then set aside without stirring.

In a 10 mL beaker, 0.125 g of ( ).04% NMP solution, DC 200® Fluid, 1000 Cs (Dow Corning) and 1.5 g 1N NH₄OH are mixed together. In a separate 100 mL beaker 10 g of MICROLITE® 963++ filler (7.5% solution, W. R. Grace) is weighed. The solution from the 10 mL beaker is added into the MICROLITE® filler while stirring with a stir bar on a stir plate. 43;4 g of distilled water is added to the resulting Solution B in the 100 mL beaker.

Solution A is then stirred, and Solution B is slowly added into Solution A with maximum stirring on the stir plate (not high shear stirring). The resulting mixture has 15.5% solids in water.

After this coating solution is applied to a polypropylene film substrate and allowed to dry, the coating contains 92.0% by weight butyl latex, 4.8% MICROLITE® filler, 3.2% BYK 306 surfactant and 0.0003% DC200 surfactant. The oxygen transmission rate (OTR) is measured using a MOCON® OX-TRAN 2/20 module. The OTR is 284.6 cc/m² day @1 atmosphere, 0% RH, 23° C. Permeability of the composition is 14.2 cc mm/m² day atmosphere @ 0% RH, 23° C. The reduction in permeability of this coating is 6.6 times the reduction in permeability of the unfilled butyl latex.

### EXAMPLE 3

Barrier Coating

Yet another aqueous elastomeric barrier coating solution according to this invention is prepared as follows, in which the elastomer is butyl latex (MW=600,000) and the filler is MICROLITE® dispersed mica at 15% by weight.

Solution A: In a 50 mL beaker, 0.32 g BYK®-306 (BYK Chemie), 3.5 g 1N NH₄OH and 26.1 g distilled water are mixed. The resulting solution is stirred on a stir plate with a stir bar. In a 2 oz glass jar, 15.1 g of Lord® BL-100 Butyl Latex (62% butyl latex solution, Lord Corporation) is weighed out. Slowly the solution in the 50 mL beaker is added into the butyl latex solution while manually stirring. The resulting Solution A is set aside without stirring.

Solution B: In a 10 mL beaker 0.04 g of 0.04% NMP solution with DC 200® Fluid, 1000 cs (Dow Corning) and 1.5 g 1N NH₄OH are mixed. In a separate 100 mL beaker 22.0 g of MICROLITE® filler is weighed, while stirring with a stir bar on a stir plate. Distilled water (31.5 g) is added to the resulting solution in the 100 mL beaker.

Solution A is stirred and Solution B is slowly added into Solution A with maximum stirring on the stir plate (without high shear stirring). The resulting mixture has 11.3% solids in water content.

After this coating solution is applied to a polypropylene film substrate and allowed to dry, the coating contains 82.6% by weight butyl rubber, 14.6% by weight MICROLITE® filler, 2.8% by weight BYK 306 surfactant and 0.00014% by weight DC200 surfactant.

The oxygen transmission rate (OTR) is measured using a MOCON® OX-TRAN 2/20 module. The OTR is 102.6 cc/m² day @ 1 atmosphere, 0% RH, 23° C. Permeability of the composition is 2.99 cc mm/m² day atmosphere @ 0% RH, 23° C. The film which results from this dried coating mixture provides a reduction in permeability of 31.4 times that of the unfilled polymer.

### EXAMPLE 4

Barrier Coating

Yet another aqueous elastomeric barrier coating solution according to this invention is prepared as follows, in which the elastomer is butyl latex (MW=600,000) and the filler is MICROLITE® dispersed mica at 20% by weight.

Solution A: In a 50 mL beaker, 0.5 g BYK®-306 (BYK Chemie), 3.0 g 1N NH₄OH and 28.6 g distilled water are added and the resulting solution stirred on a stir plate with a stir bar. In a 2 oz glass jar, 12.9 g of Lord® BL-100 Butyl Latex (62% butyl latex solution, Lord Corporation) is weighed out. Slowly the solution in the 50 mL beaker is added into the butyl latex solution while manually stirring. This Solution A is set aside without stirring.

Solution B: In a 10 mL beaker, 0.0625 g of 0.04% NMP solution of DC200® Fluid, 1000 cs (Dow Corning) and 1.5 g 1N NH₄OH are mixed together. In a separate 100 mL beaker 26.7 g of MICROLITE® 963+filler (7.5% solution, W. R. Grace) is weighed out. The solution from the 10 mL beaker is added into the MICROLITE® filler while stirring with a stir bar on a stir plate. 26.8 g of distilled water is added to the resulting solution in the 100 mL beaker.

Solution A is stirred and Solution B is slowly added to it with maximum stirring on the stir plate without high shear stirring. The resulting coating mixture contains 10.5% solids in water.

After this coating solution is applied to a polypropylene film substrate and allowed to dry, the coating contains 76.2% by weight butyl rubber, 19.1% by weight MICROLITE® filler, 4.7% BYK 306 surfactant, and 0.00024% DC200 surfactant. The oxygen transmission rate (OTR) is measured using a MOCON® OX-TRAN 2/20 module. The OTR is 89.4 cc/m² day @ 1 atmosphere, 0% RH, 23° C. Permeability of the composition is 2.04 cc mm/m² day atmosphere @ 0% RH, 23° C. The film which results from this dried coating mixture provides a reduction in permeability of 46.1 times that of the unfilled polymer.

### EXAMPLE 5

Barrier Coating

Yet another aqueous elastomeric barrier coating solution according to this invention is prepared as follows, in which the elastomer is butyl latex (MW=600,000) and the filler is MICROLITE® dispersed mica at 25% by weight.

Solution A: In a 50 mL beaker, 0.5 g BYK®-306 (BYK Chemie), 2.5 g 1N NH₄OH and 31.1 g distilled water are added and the resulting solution stirred on a stir plate with a stir bar. In a 2 oz glass jar, 10.9 g of Lord® BL-100 Butyl Latex (62% butyl latex solution, Lord Corporation) is weighed out. Slowly, the solution in the 50 mL beaker is added into the butyl latex solution while manually stirring. This Solution A is set aside without stirring.

Solution B: In a 10 mL beaker, 0.0625 g of 0.04% NMP solution of DC200® Fluid, 1000 cs (Dow Corning) and 1.5 g 1N NH₄OH are mixed together. In a separate 100 mL beaker 30.0 g of MICROLITE® 963++ filler (7.5% solution, W. R. Grace) is weighed out. The solution from the 10 mL beaker is added into the MICROLITE® filler while stirring with a stir bar on a stir plate. 23.5 g of distilled water is added to the resulting solution in the 100 mL beaker.

Solution A is stirred and Solution B is slowly added to it with maximum stirring on the stir plate without high shear stirring. The resulting coating mixture contains 9.5% solids in water. After this coating solution is applied to a polypropylene film substrate and allowed to dry, the coating contains 70.9% by weight butyl rubber, 23.8% by weight MICROLITE® filler, 5.3% BYK 306 surfactant, and 0.00026% DC200 surfactant.

The oxygen transmission rate (OTR) is measured using a MOCON® OXTRAN 2/20 module. The OTR is 40.2 cc/m² day @ 1 atmosphere, 0% RH, 23° C. Permeability of the composition is 1.0 cc mm/m² day atmosphere @ 0% RH, 23° C. The film which results from this dried coating mixture provides a reduction in permeability of 88.3 times that of the unfilled polymer.

### EXAMPLE 6

Barrier Coating

Yet another aqueous elastomeric barrier coating solution according to this invention is prepared as follows, in which the elastomer is butyl latex (MW=600,000) and the filler is MICROLITE® dispersed mica at 30% by weight.

Solution A: In a 50 mL beaker, 0.5 g BYK®-306 (BYK Chemie), 2.5 g 1N NH₄OH and 31.3 g distilled water are added and the resulting solution stirred on a stir plate with a stir bar. In a 2 oz glass jar, 10.7 g of Lord® BL-100 Butyl Latex (62% butyl latex solution, Lord Corporation) is weighed out. Slowly the solution in the 50 mL beaker is added into the butyl latex solution while manually stirring. This Solution A is set aside without stirring.

Solution B: In a 10 mL beaker, 0.0625 g of 0.04% NMP solution of DC200 Fluid, 1000 cs (Dow Corning) and 1.5 g 1N NH₄OH are mixed together. In a separate 100 mL beaker 38.0 g of MICROLITE® 963++ filler (7.5% solution, W. R. Grace) is weighed out. The solution from the 10 mL beaker is added into the MICROLITE® filler while stirring with a stir bar on a stir plate. 15.5 g of distilled water is added to the resulting solution in the 100 mL beaker.

Solution A is stirred and Solution B is slowly added to it with maximum stirring on the stir plate without high shear stirring. The resulting coating mixture contains 10% solids in water.

After this coating solution is applied to a polypropylene film substrate and allowed to dry, the coating contains 66.3% by weight butyl rubber, 28.7% by weight MICROLITE® filler, 5.0% BYK 306 surfactant, and 0.00025% DC200 surfactant.

The oxygen transmission rate (OTR) is measured using a MOCON® OX-TRAN 2/20 module. The OTR is 32.6 cc/m² day @ 1 atmosphere, 0% RH, 23° C. Permeability of the composition is 0.55 cc mm/m² day atmosphere @ 0% RH, 23° C. The film which results from this dried coating mixture provides a reduction in permeability of 110.6 times that of the unfilled polymer.

### EXAMPLE 7

Barrier Coating

Yet another aqueous elastomeric barrier coating solution according to this invention is prepared as follows, in which the elastomer is butyl latex (MW=600,000) and the filler is MICROLITE® dispersed mica at 35% by weight.

Solution A: In a 50 mL beaker, 0.5 g BYK®-306 (BYK Chemie), 1.16 g 1N NH₄OH and 35.0 g distilled water are added and the resulting solution stirred on a stir plate with a stir bar. In a 2 oz glass jar, 8.4 g of Lord® BL-100 Butyl Latex (62% butyl latex solution, Lord Corporation) is weighed out. Slowly the solution in the 50 mL beaker is added into the butyl latex solution while manually stirring. This Solution A is set aside without stirring.

Solution B: In a 10 mL beaker, 0.125 g of 0.04% NMP solution of DC200® Fluid, 1000 cs (Dow Corning) and 1.5 g 1N NH₄OH are mixed together. In a separate 100 mL beaker 37.3 g of MICROLITE® 0963++ filler (7.5% solution, W. R. Grace) is weighed out. The solution from the 10 mL beaker is added into the MICROLITE® filler while stirring with a stir bar on a stir plate. 16.5 g of distilled water is added to the resulting solution in the 100 mL beaker.

Solution A is stirred and Solution B is slowly added to it with maximum stirring on the stir plate without high shear stirring. The resulting coating mixture contains 8.5% solids in water.

After this coating solution is applied to a polypropylene film substrate and allowed to dry, the coating contains 61.2% by weight butyl rubber, 32.9% by weight MICROLITE® filler, 5.9% BYK 306 surfactant, and 0.00059% DC200 surfactant.

The oxygen transmission rate (OTR) is measured using a MOCONO° OX-TRAN 2/20 module. The OTR is 26.8 cc/M² day @ 1 atmosphere @ 0% RH, 23° C. Permeability of the composition is 0.55 cc mm/m² day atmosphere @ 0% RH, 23° C. The film which results from this dried coating mixture provides a reduction in permeability of 171 times that of the unfilled polymer.

### EXAMPLE 8

Barrier Coating

Yet another aqueous elastomeric barrier coating solution for use in the invention is prepared as follows, in which the elastomer is butyl latex (MW=600,000) and the filler is MICROLITE® dispersed mica at 18.7% by weight.

Solution A: In a 500 mL beaker, 7.0 g BYK®-306 (BYK Chemie), 17.9 g 1N NH₄OH and 296.1 g distilled water are added and the resulting solution stirred on a stir plate with a stir bar. In a 16 oz. glass jar, 129 g of Lord® BL-100 Butyl Latex (62% butyl latex solution, Lord Corporation) is weighed out. Slowly the solution in the 500 mL beaker is added into the butyl latex solution while manually stirring. This Solution A is set aside without stirring.

Solution B: In a 100 mL beaker, 1.25 g of 0.04% NMP solution of DC200® Fluid, 1000 cs (Dow Corning) and 8 g 1N NH₄OH are mixed together. In a separate 1000 mL beaker 266.7 g of MICROLITE® 963++ filler (7.5% solution, W. R. Grace) is weighed out. The solution from the 100 mL beaker is added into the MICROLITE® filler while stirring with a stir bar on a stir plate. 274 g of distilled water is added to the resulting solution in the 1000 mL beaker.

Solution A is stirred and Solution B is slowly added to it with maximum stirring on the stir plate without high shear stirring. The resulting coating mixture contains 8.5% solids in water.

After this coating solution is applied to a polypropylene film substrate and allowed to dry, the coating contains 74.8% by weight butyl rubber, 18.7% by weight MICROLITE® filler, 6.5% BYK 306 surfactant, and 0.00047% DC200 surfactant.

The oxygen transmission rate (OTR) is measured using a MOCON® OX-TRAN 2/20 module. The OTR is 123.2 cc/m² day @ 1 atmosphere @ 0% RH, 23° C. Permeability of the composition is 2.96 cc mm/m² day atmosphere @ 0% RH, 23° C. The film which results from this dried coating mixture provides a reduction in permeability of 31.6 times that of the unfilled polymer.

### EXAMPLE 9

Barrier Coating Compositions Which Vary % MICROLITE® Vermiculite with % Solids

A. 16.0% Solids in Water: 95% butyl latex, 5% MICROLITE® filler

Part A: In a 4 oz glass jar, 24.7 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 3.4 g of 1N NH₄OH and 16.8 g distilled water are mixed into solution, and the solution in the 30 mL beaker is slowly added into the butyl latex solution while stirring slowly.

Part B: In a 50 mL beaker, 44.0 g distilled water and 0.32 g 1N NH₄OH are mixed. In a separate 100 mL beaker 10.7 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (21.5 microns) is formed on polypropylene from the above coating solution. The film results in an OTR of 386.1 cc/m² day @ 1 atm, 23° C., 0% RH, and a permeability of 15.3 cc mm/m² day atm @ 23° C., 0% RH, which results in a reduction in permeability of 6.2 times. The butyl/filler ratio equals 19.0:1.

B. 15.0% Solids in Water: 90% butyl latex, 10% MICROLITE® filler

Part A: In a 4 oz glass jar, 21.9 g of Lords BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 3.1 g of 1N NH₄OH and 19.9 g distilled water are mixed into solution, and the solution in the 30 mL beaker is slowly added into the butyl latex solution while stirring slowly.

Part B: In a 50 mL beaker, 34.4 g distilled water and 0.6 g 1N NH₄OH are mixed. In a separate 100 mL beaker 20.0 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (22 microns) is formed on polypropylene from the above coating solution. The film results in an OTR of 166.5 cc/m² day @ 1 atm, 23° C., 0% RH, and a permeability of 4.57 cc mm/m² day atm @ 23° C., 0% RH, which results in a reduction in permeability of 20.7 times. The butyl/filler ratio equals 9.0:1.

C. 12.0% Solids in Water: 85% Butyl Latex, 15% MICROLITE® Filler

Part A: In a 4 oz glass jar, 16.5 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 2.3 g of 1N NH₄OH and 26.1 g distilled water are mixed into solution, and the solution in the 30 mL beaker is slowly added into the butyl latex solution while stirring slowly.

Part B: In a 50 mL beaker, 30.3 g distilled water and 0.7 g 1N NH₄OH are mixed. In a separate 100 mL beaker 24.0 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (16.75 microns) is formed on polypropylene from the above coating solution. The film results in an OTR of 108.1 cc/m² day @1 atm, 23° C., 0% RH, and a permeability of 2.08 cc mm/m² day atm @ 23° C., 0% RH, which results in a reduction in permeability of 45.4x. The butyl/filler ratio equals 5.65:1.

D. 10.0% Solids in Water: 80% Butyl Latex, 20% MICROLITE® Filler

Part A: In a 4 oz glass jar, 13.0 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.8 g of 1N NH₄OH and 30.1 g distilled water are mixed into solution, and the solution in the 30 mL beaker is slowly added into the butyl latex solution while stirring slowly.

Part B: In a 50 mL beaker, 27.5 g distilled water and 0.8 g 1N NH₄OH are mixed. In a separate 100 mL beaker 26.7 g of MICROLITE® OR 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (16.25 microns) is formed on polypropylene from the above coating solution. The film results in an OTR of 56.3 cc/m² day @ 1 atm, 23° C., 0% RH, and a permeability of 0.9 cc mm/m² day @ atm 23° C., 0% RH, which results in a reduction in permeability of 104.9 times. The butyl/filler ratio equals 4.00:1.

E. 9.0% Solids in Water: 75% Butyl Latex, 25% MICROLITE® Filler

Part A: In a 4 oz glass jar, 11.0 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.5 g of 1N NH₄OH and 32.4 g distilled water are mixed into solution, and the solution in the 30 mL beaker is slowly added into the butyl latex solution while stirring slowly.

Part B: In a 50 mL beaker, 24.1 g distilled water and 0.9 g 1N NH₄OH are mixed. In a separate 100 mL beaker 30 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (12.0 microns) is formed on polypropylene from the above coating solution. The film results in an OTR of 37.5 cc/m² day @ 1 atm, 23° C., 0% RH, and a permeability of 0.47 cc mm/m² day atm @ 23° C., 0% RH, which results in a reduction in permeability of 200.9 times. The butyl/filler ratio equals 3.00:1.

F. 8.0% Solids in Water: 70% Butyl Latex, 30% MICROLITE® Filler

Part A: In a 4 oz glass jar, 9.1 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.3 g of 1N NH₄OH and 34.5 g distilled water are mixed into solution, and the solution in the 30 mL beaker is slowly added into the butyl latex solution while stirring slowly.

Part B: In a 50 mL beaker, 22.0 g distilled water and 1.0 g 1N NH₄OH are mixed. In a separate 100 mL beaker 32 g of MICROLITE®) 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (15.8 microns) is formed on polypropylene from the above coating solution. The film results in an OTR of 15.7 cc/m² day @1 atm, 23° C., 0% RH, and a permeability of 0.25 cc mm/m² day atm @ 23° C., 0% RH, which results in a reduction in permeability of 377.6 times. The butyl/filler ratio equals 2.34:1.

G. 7.5% Solids in Water: 65% Butyl Latex, 35% MICROLITE® Filler

Part A: In a 4 oz glass jar, 7.9 g of Lords BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.1 g of 1NH₄OH and 35.9 g distilled water are mixed into solution, and the solution in the 30 mL beaker is slowly added into the butyl latex solution while stirring slowly.

Part B: In a 50 mL beaker, 19.0 g distilled water and 1.0 g 1N NH₄OH are mixed. In a separate 100 mL beaker 35 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (11.6 microns) is formed on polypropylene from the above coating solution. The film results in an OTR of 16.8 cc/m² day @ 1 atm, 23° C., 0% RH, and a permeability of 0.20 cc mm/m² day atm @ 23° C., 0% RH, which results in a reduction in permeability of 472.0 times. The butyl/filler ratio equals 1.85:1.

H. 6.0% Solids in Water: 60% Butyl Latex, 40% MICROLITE® Filler

Part A: In a 4 oz glass jar, 5.8 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 0.8 g of 1N NH₄OH and 38.3 g distilled water are mixed into solution, and the solution in the 30 mL beaker is slowly added into the butyl latex solution while stirring slowly.

Part B: In a 50 mL beaker, 22.0 g distilled water and 1.0 g 1N NH₄OH are mixed. In a separate 100 mL beaker 32 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (4.0 microns) is formed on polypropylene from the above coating solution. The film results in an OTR of 21.5 cc/M² day @1 atm 23° C., 0% RH, and a permeability of 0.081 cc mm/m² day atm @ 23° C., 0% RH, which results in a reduction in permeability of 1165.4 times. The butyl/filler ratio equals 1.49:1.

I. 5.5% Solids in Water: 55% Butyl Latex, 45% MICROLITE® Filler

Part A: In a 4 oz glass jar, 4.9 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 0.7 g of 1N NH₄OH and 39.3 g distilled water are mixed into solution, and the solution in the 30 mL beaker is slowly added into the butyl latex solution while stirring slowly.

Part B: In a 50 mL beaker, 21.0 g distilled water and 1.0 g 1N NH₄OH are mixed. In a separate 100 mL beaker 33 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (3.6 microns) is formed on polypropylene from the above coating solution. The film results in an OTR of 20.6 cc/m² day @ 1 atm, 23° C., 0% RH, and a permeability of 0.076 cc mm/m² day atm @ 23° C., 0% RH, which results in a reduction in permeability of 1241.1 times. The butyl/filler ratio equals 1.22:1.

J. 5.0% Solids in Water: 50% Butyl Latex, 50% MICROLITE® Filler

Part A: In a 4 oz glass jar, 4.0 g of Lord® BL-100 Butyl Latex (61.66/o butyl latex solution, Lord Corporation) is measured. This latex is stirred slowly with a stir bar on a stir plate. In a 30 mL beaker, 0.1 g BYK®-306 wetting agent (BYK Chemie), 0.6 g of 1N NH₄OH and 40.3 g distilled water are mixed into solution, and the solution in the 30 mL beaker is slowly added into the butyl latex solution while stirring slowly.

Part B: In a 50 mL beaker, 20.7 g distilled water and 1.0 g 1N NH₄OH are mixed. In a separate 100 mL beaker 33.3 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (2.55 microns) is formed on polypropylene from the above coating solution. The film results in an OTR of 17.0 cc/m² day @ 1 atm, 23° C., 0% RH, and a permeability of 0.041 cc mm/m² day atm @ 23° C., 0% RH, which results in a reduction in permeability of 2302.4 times. The butyl/filler ratio equals 1.00:1.

K. T0.0% Solids in Water: 80% Butyl Latex, 20% MICROLITE® Filler

Part A: In a 4 oz glass jar, 13.0 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.8 g of 1N NH₄OH and 30.1 g distilled water are mixed into solution, and the solution in the 30 mL beaker is slowly added into the butyl latex solution while stirring slowly.

Part B: In a 50 mL beaker, 27.5 g distilled water and 0.8 g 1N NH₄OH are mixed. In a separate 100 mL beaker 26.7 of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (9.75 microns) is formed on polypropylene from the above coating solution. The film results in an OTR of 53.5 cc/m² day @ 1 atm, 23° C., 0% RH, and a permeability of 1.0 cc mm/m² day atm @ 23° C., 0% RH, which results in a reduction in permeability of 94.4 times. The butyl/filler ratio equals 4.00:1.

L. 10.0% Solids in Water: 80% butyl latex, 20% MICROLITE® filer

Part A: In a 4 oz glass jar, 13.0 g of Lord® BL-100 Butyl Latex (61.6% butyl latex solution, Lord Corporation) is measured. This latex is stirred slowly with a stir bar on a stir plate. In a 30 mL beaker, 0.1 g BYK®-306 wetting agent (BYK Chemie), 1.8 g of 1N NH₄OH and 30.1 g distilled water are mixed into solution, and the solution in the 30 mL beaker is slowly added into the butyl latex solution while stirring slowly.

Part B: In a 50 mL beaker, 27.5 g distilled water and 0.8 g 1N NH₄OH are mixed. In a separate 100 mL beaker 26.7 g of MICROLITE® 963++ filler (7.5% solution, W. R. Grace) is measured, and the solution from the 50 mL beaker is added into the MICROLITE® filler while stirring with a stir bar on a stir plate.

Slowly Part B is added into Part A with medium stirring on the stir plate, avoiding high shear stirring.

A barrier film (10.85 microns) is formed on polypropylene from the above coating solution. The film results in an OTR of 70.3 cc/m² day @ 1 atm, 23°., 0% RH, and a permeability of 0.82 cc mm/m² day atm @ 23° C., 0% RH, which results in a reduction in permeability of 115.1 times. The butyl/filler ratio equals 4.00:1.

### EXAMPLE 10

Barrier Compositions Varying % Solids with 15% MICROLITE® Filler

A. 20.0% Solids in Water: 85% Polymer Latex butyl latex, 15% MICROLITE® Filler

Part A: In a 30 mL beaker, 0.075 g BYK®-023 wetting agent and 8.2 g distilled water are combined. The resulting solution is stirred on a stir plate with a stir bar. In a 4 oz glass jar, 25.5 g of Polymer Latex ELR Butyl Latex (50% butyl latex solution, research sample from Polymer Latex) is measured. The solution in the 30 mL beaker is slowly added into the butyl latex solution while manually stirring and the solution set aside without further stirring.

Part B: In a 30 mL beaker, 10.3 g distilled water and 0.9 g 1N NH₄OH are mixed. In a separate 100 mL beaker 30 g of MICROLITE® 963++ filler is measured. The solution from the 30 mL beaker is added into the MICROLITE® filler while stirring with a stir bar on a stir plate.

Stirring of Part A is resumed and Part B is slowly added into Part A with maximum stirring on the stir plate, avoiding high shear stirring.

A barrier film (17.3 microns) on polypropylene from the above coating solution resulted in an OTR of 165 cc/m² day @ 1 atm, 23° C., 0% RH, and a permeability of 3.7 cc mm/m² day atm @ 23° C., 0% RH, which results in a reduction in permeability of 25.4 times. Butyl/filler ratio equals 5.67:1.

B. 25.0% Solids in Water: 85.0% Butyl Latex, 15.0% MICROLITE® Filler

Part A: In a 10 mL beaker, 0.075 g BYK®-023 wetting agent and 1.9 g distilled water are combined. The resulting solution is stirred on a stir plate with a stir bar. In a 4 oz glass jar, 31.9 g of Polymer Latex ELR Butyl Latex (50% butyl latex solution, research sample from Polymer Latex) is measured. The solution in the 10 mL beaker is slowly added into the butyl latex solution while manually stirring and the solution set aside without stirring.

Part B: In a 10 mL beaker, 2.6 g distilled water and 1.1 g 1N NH₄OH are mixed. In a separate 100 mL beaker 37.5 g of MICROLITE® 963++ filler is measured. The solution from the 10 mL beaker is added into the MICROLITE® filler while stirring with a stir bar on a stir plate.

Stirring of Part A is resumed and Part B is slowly added into Part A with maximum stirring on the stir plate, avoiding high shear stirring.

A barrier film (20.9 microns) on polypropylene from the above coating solution resulted in an OTR of 125.6 cc/m² day @ 1 atm, 23° C., 0% RH, and a permeability of 3.2 cc mm/m² day atm @ 23° C., 0% RH, which results in a reduction in permeability of 29.5 times. Butyl/filler ratio equals 5.67:1.

C. 27.0% Solids in Water: 85.0% Butyl Latex, 15.0% MICROLITE® Filler

Part A: In a 4 oz glass jar, 35.0 g of Polymer Latex ELR Butyl Latex and 0.15 g BYK®-023 wetting agent are measured and slowly stirred with a stir bar on a stir plate.

Part B: In a 100 mL beaker 41.2 g of MICROLITE® 963++ filler is measured.

Part B is slowly added into Part A with maximum stirring on the stir plate, avoiding high shear stirring.

A barrier film (23.9 microns) on polypropylene from the above coating solution resulted in an OTR of 162.8 cc/m² day @ 1 atm, 23° C., 0% RH, and a permeability of 5.0 cc mm/m² day atm @ 23° C., 0% RH which results in a reduction in permeability of 18.9x. Butyl/filler ratio-5.66:1.27% is the maximum solids content achieved without removing water from the latex.

### EXAMPLE 11

Barrier Coating using Bromo-Butyl-Latex and Varying % Solids with 20% MICROLITE® Filler

A. 15.0% Solids in Water: 80.0% Butyl Latex, 20.0% MICROLITE® filler

Part A: In a 50 mL beaker, 0.1 g BYK®-306 wetting agent, 3.2 g 1N NH₄OH and 18.5 g distilled water are measured and the resulting solution stirred on a stir plate with a stir bar. In a 4 oz glass jar, 23.2 g of Polymer Latex ELR Bromobutyl Latex (51.7% bromo-butyl latex solution, research sample from Polymer Latex) is measured. The solution in the 50 mL beaker is slowly added into the butyl latex solution while manually stirring, and the resulting solution set aside without stirring.

Part B: In a 30 mL beaker, 13.8 g distilled water and 1.2 g 1N NH₄OH are mixed. In a separate 100 mL beaker, 40 g of MICROLITE® 963++ filler are measured. The solution from the 30 mL beaker is added into the MICROLITE® filler while stirring with a stir bar on a stir plate.

Stirring of Part A is resumed. Part B is slowly added into Part A with maximum stirring on the stir plate, avoiding high shear stirring.

A barrier film (15.3 microns) on polypropylene from the above coating solution resulted in an OTR of 180.5 cc/m² day @ 1 atm, 23° C., 0% RH, and a permeability of 3.52 cc mm/m² day atm @ 23° C., 0% RH which results in a reduction in permeability of 28.7 times. Bromo-butyl/filler ratio=4.00:1.

B. 18.0% Solids in Water: 80.0% Butyl Latex, 20.0% MICROLITE® filler

Part A: In a 50 mL beaker, 0.1 g BYK®-306 wetting agent, 3.9 g 1N NH₄OH and 13.1 g distilled water are combined and the resulting solution stirred on a stir plate with a stir bar. In a 4 oz glass jar, 27.9 g of Polymer Latex ELR Bromobutyl Latex is measured; the solution in the 50 mL beaker is slowly added into the butyl latex solution while manually stirring. This solution is set aside without stirring.

Part B: In a 30 mL beaker, 5.6 g distilled water and 1.4 g 1N NH₄OH are mixed. In a separate 100 mL beaker 48 g of MICROLITE® 963++ filler are measured. The solution from the 30 mL beaker is added into the MICROLITE® filler while stirring with a stir bar on a stir plate. Stirring of Part A is resumed. Part B is slowly added into Part A with maximum stirring on the stir plate, avoiding high shear stirring.

A barrier film (23.6 microns) on polypropylene from the above coating solution resulted in an OTR of 94.6 cc/m² day @ 1 atm, 23° C., 0% RH, and a permeability of 2.52 cc mm/m² day @ atm 23° C., 0% RH which results in a reduction in permeability of 40.1 times. Bromo-butyl/filler ratio=4.01:1.

C. 20.0% Solids in Water: 80.0% Butyl Latex, 20.0% MICROLITE® Filler

Part A: In a 30 mL beaker, 0.1 g BYK®-306 wetting agent, 4.3 g 1N NH₄OH and 9.7 g distilled water are combined. The resulting solution is stirred on a stir plate with a stir bar. In a 4 oz glass jar, 30.9 g of Polymer Latex ELR Bromobutyl Latex is measured. The solution in the 30 mL beaker is slowly added into the butyl latex solution while manually stirring. This solution is set aside without stirring.

Part B: In a 10 mL beaker, 0.1 g distilled water and 1.6 g 1N NH₄OH are mixed. In a separate 100 mL beaker 53.3 g of MICROLITE® 963++ filler is measured. The solution from the 10 mL beaker is added into the MICROLITE® filler while stirring with a stir bar on a stir plate.

Stirring of Part A is resumed. Part B is slowly added into Part A with maximum stirring on the stir plate, avoiding high shear stirring.

A barrier film (19.3 microns) on polypropylene from the above coating solution resulted in an OTR of 104.8 cc/m² day @ 1 atm, 23° C., 0% RH, and a permeability of 2.31 cc mm/m² day atm @ 23° C., 0% RH which results in a reduction in permeability of 43.8 times. Bromo-butyl/filler ratio=4.00:1.

D. 22.8% Solids in Water: 80.0% Butyl Latex, 20.0% MICROLITE® Filler

Part A: In a 10 mL beaker, 0.1 g BYK®-306 wetting agent, 3.0 g 1N NH₄OH and 0.0 g distilled water are combined. The resulting solution is stirred on a stir plate with a stir bar. In a 4 oz glass jar, 35.6 g of Polymer Latex ELR Bromobutyl Latex is measured. The solution in the 10 mL beaker is slowly added into the butyl latex solution while manually stirring. This solution is set aside without stirring.

Part B: In a 10 mL beaker, 1.0 g distilled water and 0.0 g 1N NH₄OH are mixed. In a separate 100 mL beaker 61.3 g of MICROLITE® 963++ filler is measured. The solution from the 10 mL beaker is added into the MICROLITE® filler while stirring with a stir bar on a stir plate.

Stirring of Part A is resumed. Part B is slowly added into Part A with maximum stirring on the stir plate, avoiding the use of high shear stirring.

A barrier film (18.1 microns) on polypropylene from the above coating solution resulted in an OTR of 153.4 cc/m² day @ 1 atm, 23° C., 0% RH, and a permeability of 3.4 cc mm/m² day atm @ 23° C., 0% RH which results in a reduction in permeability of 29.7 times. Bromo-butyl/filler ratio=4.00:1.

### EXAMPLE 12

Barrier Coatings Varying % MICROLITE® Filler with 20% Solids using Bromo-Butyl Latex

A. 20.0% Solids in Water: 85.0% butyl latex, 15. % MICROLITE® filler

Part A: In a 30 mL beaker, 0.1 g BYK®-306 wetting agent, 4.6 g 1N NH₄OH and 7.4 g distilled water are combined and the resulting solution stirred on a stir plate with a stir bar. In a 4 oz glass jar, 32.9 g of Polymer Latex ELR Bromobutyl Latex (51.7% bromo-butyl latex solution, research sample from Polymer Latex) is measured. The solution in the 30 mL beaker is slowly added into the butyl latex solution while manually stirring. This solution is set aside without stirring.

Part B: In a 30 mL beaker, 13.8 g distilled water and 1.2 g 1N NH₄OH are mixed. In a separate 100 mL beaker 40 g of MICROLITE® 963++ filler is measured. The solution from the 30 mL beaker is added into the MICROLITE® filler while stirring with a stir bar on a stir plate.

Stirring of Part A is resumed. Part B is slowly added into Part A with maximum stirring on the stir plate, avoiding high shear stirring.

A barrier film (19.6 microns) on polypropylene from the above coating solution resulted in an OTR of 172.2 cc/m² day @ 1 atm, 23° C., 0% RH, and a permeability of 4.25 cc mm/m² day atm @ 23° C., 0% RH which results in a reduction in permeability of 23.8 times. Bromo-butyl/filler ratio=5.67:1.

B. 20.0% Solids in Water: 80.0% Gutyl Latex, 20.0% MICROLITE® filler

Part A: In a 30 mL beaker, 0.1 g BYK®-306 wetting agent, 4.3 g 1N NH₄OH and 9.7 g distilled water are combined and the resulting solution stirred on a stir plate with a stir bar. In a 4 oz glass jar, 30.9 g of Polymer Latex ELR Bromobutyl Latex is measured. The solution in the 30 mL beaker is slowly added into the butyl latex solution while manually stirring; this solution is set aside without stirring.

Part B: In a 10 mL beaker, 0.1 g distilled water and 1.6 g 1N NH₄OH are mixed. In a separate 100 mL beaker 53.3 g of MICROLITE® 963++ filler is measured. The solution from the 10 mL beaker is added into the MICROLITE® filler while stirring with a stir bar on a stir plate.

Stirring of Part A is resumed and Part B is slowly added into Part A with maximum stirring on the stir plate, avoiding high shear stirring.

A barrier film (38.2 microns) on polypropylene from the above coating solution resulted in an OTR of 56.7 cc/m² day @ 1 atm, 23° C., 0% RH, and a permeability of 2.32 cc mm/m² day atm @ 23° C., 0% RH which results in a reduction in permeability of 43.6 times. Bromo-butyl/filler ratio=4.00:1.

C. 20.0% Solids in Water: 75.0% Butyl Latex, 25.0% MICROLITE® filler

Part A: In a 10 mL beaker, 0.1 g BYK®-306 wetting agent, 3.0 g 1N NH₄OH and 0.0 g distilled water are mixed and the resulting solution stirred on a stir plate with a stir bar. In a 4 oz glass jar, 29.0 g of Polymer Latex ELR Bromo-butyl Latex is measured. The solution in the 10 mL beaker is slowly added into the butyl latex solution while manually stirring and this solution set aside without stirring.

Part B: In a 100 mL beaker 66.7 g of MICROLITE® 963++ filler is measured. 1.6 g 1N NH₄OH is added to the MICROLITE® filler while stirring with a stir bar on a stir plate.

Stirring of Part A is resumed and Part B is slowly added into Part A with maximum stirring on the stir plate, avoiding high shear stirring.

A barrier film (20.5 microns) on polypropylene from the above coating solution resulted in an OTR of 67.4 cc/m² day @ 1 atm, 23° C., 0% RH, and a permeability of 1.5 cc mm/m² day atm @ 23° C., 0% RH which results in a reduction in permeability of 67.4 times. Bromo-butyl/filler ratio=3.00:1.

### EXAMPLE 13

Barrier Coating with Butyl Latex Applied to Carcass Rubber Substrate

The elastomeric barrier coating solution described in Example 3 above is applied onto another substrate, an elastomeric substrate referred to as “carcass rubber”. Carcass rubber is a mixture of styrene-butadiene rubber, butadiene rubber and natural rubber.

After the coating solution described in Example 3 is applied to the carcass rubber substrate and allowed to dry, it demonstrates an OTR (measured using a MOCON® OX-TRAN 2/20 module) of 82 cc/m² day @ 1 atmosphere, 0% RH, 23° C. Permeability of the composition is 1.8 cc mm/m² day atmosphere ( ) 0% RH, 23° C. The coating which results from this dried coating mixture provides a reduction in permeability of 52.5 times that of the unfilled polymer.

The coated substrate is then subjected to stress. The coated carcass rubber is flexed about 1100 times at 10% elongation. After flex, the OTR and permeability of the coating is again measured as described above. The OTR of the flexed coated substrate is 173.5 cc/m² day @ 1 atmosphere, 0% RH, 23° C. Permeability of the coating on the flexed substrate is 4.2 cc mm/m² day atmosphere @ 0% RH, 23° C. The coating after flex on the substrate provides a reduction in permeability of 22.4 times that of the unfilled polymer.

### EXAMPLE 14

Barrier Coating Containing 5% PVOH Terpolymer

Another exemplary barrier coating formulation of the present invention comprises 10% solids in water, 75% by weight butyl latex, 20% by weight MICROLITE® filler, and 5% PVOH terpolymer as a thickener. The coating is prepared as follows:

Part A: In a 4 oz glass jar, 11.47 g of Lord® BL-100™Butyl Latex is measured, and stirred slowly on a stir plate with a stir bar. In a 50 mL beaker, 0. Ig BYK®G 306 wetting agent, 1.57 g of 1N NH₄OH and 31.84 g distilled water are mixed. The solution in the 50 mL beaker is added into the butyl latex solution while stirring slowly.

Part B: In a 50 mL beaker, 0.5 g of Mowiol® terpolymer of PVB (poly(vinylbutyral))/PVA (poly(vinylacetate))/PVOH (poly(vinylalcohol)) (Hoechst) and 25 g of distilled water are mixed. A stir bar is added to this solution and the solution is heated in a water bath with stirring until dissolved. In a separate 30 mL beaker, 0.8 g of 1N NH₄OH and 2.03 g distilled water are mixed. In a separate 100 mL beaker, 26.67 g of MICROLITE® 963++ filler is measured and the solution from the 30 mL beaker is added into the MICROLITE® filler while stirring with a stir bar on a stir plate. To the resulting solution in the 100 mL beaker, the dissolved PVOH solution is added while stirring.

Slowly Part B is added into Part A with medium stirring on the stir plate, avoiding high shear stirring. The resulting formulation had a viscosity of 326 cP (Brookfield DVII+, 60 rpm, 25° C.) which is an increase from a viscosity of 4.5 cP (Brookfield DVII+, 60 rpm, 25° C.) of the formulation without the PVOH terpolymer thickener.

A barrier film (4.9 microns) on polypropylene from the above coating solution resulted in an OTR of 171.1 cc/m² day @ 1 atm, 23° C., 0% RH, a permeability of 1.05 cc mm/m² day atm @ 23° C., 0% RH which results in a reduction in permeability of 89.9x. Butyl/filler ratio equals 3.7:1.

### EXAMPLE 15

Barrier Coating Containing 5.5% PVOH Terpolymer

Another exemplary barrier coating formulation of the present invention comprises 10% solids in water, 74.5% by weight butyl latex, 20% by weight MICROLITE® filler, and 5.5% PVOH terpolymer as a thickener. The coating is prepared as follows:

Part A: In a 8 oz glass jar, 28.48 g of Lord® BL-100™ Butyl Latex is measured. A stir bar is added and the latex stirred slowly on a stir plate. In a 100 mL beaker, 0.25 g BYK® 306 wetting agent, 3.96 g of 1N NH₄OH and 79.81 g distilled water are mixed. The solution in the 100 mL beaker is slowly added into the butyl latex solution while stirring slowly.

Part B: In a first 50 mL beaker, 1.375 g of Mowiol® terpolymer of PVB (poly(vinylbutyral))/PVA (poly(vinylacetate))/PVOH (poly(vinylalcohol)) (Hoechst) and 30 g of distilled water are mixed. A stir bar is added to this solution and the solution is heated in a water bath with stirring until dissolved. In a second 50 mL beaker, 2.0 g of 1N NH₄OH and 37.46 g distilled water are mixed. In a separate 150 mL beaker, 66.67 g of MICROLITE® 963++ filler is measured. The solution from the second 50 mL beaker is added into the MICROLITE® filler while stirring with a stir bar on a stir plate. To the resulting solution in the 150 mL beaker, the dissolved PVOH solution is added while stirring.

Part B is added into Part A with medium stirring on the stir plate, avoiding high shear stirring. The resulting formulation had a viscosity of 370 cP (Brookfield DVII+, 60 rpm, 25° C.) which is an increase from a viscosity of 4.5 cP (Brookfield DVII+, 60 rpm, 25° C.) of the formulation without the PVOH terpolymer thickener.

A barrier film (4.0 microns) on polypropylene from the above coating solution resulted in an OTR of 130.8 cc/m² day @ 1 atm, 23° C., 0% RH, a permeability of 0.62 cc mm/m² day atm @ 23° C., 0% RH which results in a reduction in permeability of 152.2x. Butyl/filler ratio equals 3.7:1.

### EXAMPLE 16

Barrier Coating Containing 4.3% Lithium chloride and Cure Package

Another exemplary barrier coating of the present invention contains 11.7% solids in water, 68.4% by weight butyl latex, 17.1% w/w MICROLITE® filler, 4.3% w/w lithium chloride as a thickener and 10.2% w/w of a “cure package” to enhance curing of the coating on a substrate. The barrier coating was prepared as follows:

Part A: In a 8 oz glass jar, 78.2 g of Lord® BL-100™ Butyl Latex was measured and a stir bar was added. This solution was stirred slowly on a stir plate. In a 150 mL beaker, 0.3 g BYK® 306 wetting agent, 10.9 g of 1N N₄OH and 118.5 g distilled water are combined. The solution in the 150 mL beaker is slowly added into the butyl latex solution while stirring slowly. The glass jar is placed into a 70° C. water bath with mechanical stirring. Stirring in the 70° C. bath is continued for 15 minutes and then 13.8 g of a cure package Ti-Rite #Ml (containing about 21.4% by weight zinc oxide, about 10-11% by weight sulfur, about 47-48% by weight water, about 23% of a dispersing agent, about 14-15% of zinc dibutyldithio-carbamate and about 34% zinc 2-mercaptobenzothiazole, Technical Industries, Inc.) is added. The solution is stirred and heated for 2 hours, after which it is removed from the 70° C. water bath to a 25° C. water bath with stirring until cooled. 3 g lithium chloride (Fisher Scientific) dissolved in 75 g distilled water is added and the solution stirred for 1 hour. After 1 hour, 0.3 g FOAMASTER VL defoamer (Henkel) is added to the cooled solution, which is stirred for 5 minutes.

Part B: In a 150 mL beaker, 4.8 g of 1NH₄OH and 135.2 g distilled water are mixed. In a separate 250 mL beaker, 160.0 g of MICROLITE® 963++ filler is measured. The solution from the 150 mL beaker is added into the MICROLITE® filler while stirring with a stir bar on a stir plate.

Part B is added slowly into Part A with medium stirring on the stir plate, avoiding high shear stirring. The resulting formulation had a viscosity of 8120 cP (Brookfield DVII+, 0.396 rpm, 25° C.) which is an increase from a viscosity of 4.5 cP (Brookfield DVII+, 60 rpm, 25° C.) of the formulation without the lithium chloride thickener.

A barrier film (13.9 microns) on polypropylene from the above coating solution resulted in an OTR of 59.7 cc/m² day @ 1 atm, 23° C., 0% RH, and a permeability of 0.89 cc mm/m² day atm @ 23° C., 0% RH which results in a reduction in permeability of 106.1 times. Butyl/filler ratio equals 4.0:1.

A barrier film was coated onto butyl rubber and cured at 170° C. for 20 minutes in an oven. The cured barrier film (13.4 microns) on butyl rubber from the above coating solution resulted in an OTR of 53.7 cc/m² day @ 1 atm, 23° C., 0% RH, and a permeability of 1.77 cc mm/m² day atm @ 23° C., 0% RH which results in a reduction in permeability of 53.3 times. Butyl/filler ratio equals 4.0:1.

### EXAMPLE 17

Elongation or Flex Test

In order to determine the integrity of the coatings after application to a substrate, an elongation or flex test was conducted. Essentially, the coated substrate to be evaluated is attached to one surface of a reinforced elastomeric beam. The beam is bent about its neutral axis in a cyclic fashion so that the coated substrate experiences a repeating sinusoidal tensile strain ranging from about 0.1% to about 10%. These strains are transferred from the surface of the beam to the substrate, and to the coating.

All references and patents cited above are incorporated herein by reference. Numerous modifications and variations of the present invention are included in the above-identified specification and are expected to be obvious to one of skill in the art. Such modifications and alterations to the compositions and processes of the present invention are believed to be encompassed in the scope of the claims appended hereto.

We claim:

1. An airbag comprising:
a substrate defining a compartment adapted to receive a gas under pressure; and
a barrier coating arranged on an interior or exterior surface of said fabric substrate, said barrier coating being formed by applying to said surface a solution comprising an elastomeric polymer and a dispersed exfoliated layered.

2. The airbag of claim 1, wherein the substrate is made of fabric.

3. The airbag of claim 1, wherein said filler has an aspect ratio greater than 25.

4. The airbag of claim 1, wherein said solution further comprises at least one surfactant.

5. The airbag of claim 1, wherein the solids content of said solution is less than 30% and the weight ratio of said polymer to said filler ranges from 20:1 to 1:1.

6. The airbag of claim 1, wherein the barrier coating is further formed by drying said solution.

7. The airbag of claim 1, wherein said dried barrier coating has a polymer to filler weight ratio, which ranges from 20:1 to 1:1 and wherein said coating provides at least 10-fold greater reduction in gas, vapor, and chemical permeability than a coating formed of said polymer alone.

8. The airbag of claim 1, wherein said polymer is capable of excluding or resisting the penetration of air, water, or other gas or vapors.

9. The airbag of claim 1, wherein said polymer is in a form selected from the group consisting of a solution, a dispersion, an emulsion, a suspension and a latex.

10. The airbag of claim 1, wherein said polymer is a butyl-containing polymer.

11. The airbag of claim 1 wherein said polymer is present in said solution at between about 1% to about 30% by weight.

12. The airbag of claim 1, wherein said filler is selected from the group consisting of bentonite, vermiculite, montmorillonite, nontronite, beidellite, volkonskoite, hectorite, saponite, laponite, sauconite, magadiite, kenyaite, ledikite, and mixtures and solutions of the above silicates.

13. The airbag of claim 1, wherein said dispersed layered filler is present in said solution at between about 1% to about 10% by weight.

14. The airbag of claim 1, wherein said solution has a solids content of from about 5% to about 17% by weight.

15. The airbag of claim 1, wherein said solution further comprises a component selected from the group consisting of hexane, heptane, toluene, 1-methyl-2-pyrrolidinone, cyclohexanone, ethanol, methanol, other hydrocarbons, and combinations thereof.

16. The airbag of claim 1, wherein said solution further comprises curative components which enhance the curing of said barrier coating on said substrate.

17. The airbag of claim 1, wherein said dried coating comprises about 45% to about 95% by weight of said polymer, between about 5% to about 55% by weight said dispersed layered filler; and between about 1.0% to about 15% by weight said surfactant, said filler in said dried coating or film having an effective aspect ratio greater than 25.

18. A method of manufacturing an airbag module, comprising the steps of:
applying to a surface of a substrate a solution comprising an elastomeric polymer and a dispersed exfoliated layered filler and causing the solution to dry to thereby form a barrier coating on the substrate;
forming an airbag having an edge defining an entry opening for enabling the inflation of the airbag from the substrate having the barrier coating formed thereon;
arranging the airbag in a housing;
sealing the edge of the airbag to the housing;
providing a flow communication in the housing to allow inflation fluid to pass through the entry opening into the airbag; and
folding the airbag in the housing.

19. The method of claim 18, wherein the step of forming the airbag comprises the step of cutting the substrate having the barrier coating thereon.

20. The method of claim 18, wherein the substrate is made of fabric.

21. A method of manufacturing an airbag module, comprising the steps of:
applying to a surface of a first substrate a solution comprising an elastomeric polymer and a dispersed exfoliated layered filler,
covering the solution with a second substrate;
causing the solution to dry to thereby form a barrier coating between the first and second substrates;
forming an airbag from the first and second substrates having the barrier coating therebetween with an edge defining an entry opening for enabling the inflation of the airbag;
arranging the airbag in a housing;
sealing the edge of the airbag to the housing;
providing a flow communication in the housing to allow inflation fluid to pass through the entry opening into the airbag; and
folding the airbag in the housing.

22. The method of claim 21, wherein the step of forming the airbag comprises the step of cutting the first and second substrates having the barrier coating therebetween.

23. The method of claim 21, wherein the substrate is made of fabric.

24. A method for forming a side curtain airbag, comprising the steps of:
providing a first piece for fabric constituting a front panel of the airbag and a second piece of fabric constituting a rear panel of the airbag;
heat or adhesive sealing the first and second pieces of fabric together over an extended seam width to form an airbag while maintaining an entry opening for passage of inflation fluid into an interior of the airbag;
partitioning the airbag along partition lines into a plurality of chambers each receivable of the inflation fluid; and
determining the location of the partition lines to prevent concentration of stress in the seams.

25. The method of claim 24, wherein the step of determining the location of the partition lines comprises the step of analyzing the airbag using finite element analysis.

26. The method of claim 24, further comprising the step of coating the first and second pieces of fabric with a barrier coating.

27. A method for forming an airbag, comprising the steps of:
providing a plurality of layers of material;
interweaving, heat sealing or sewing the layers together to form the airbag while maintaining an entry opening for passage of inflation fluid into an interior of the airbag; and
coating the airbag with a barrier coating.

28. The method of claim 27, wherein the layers are interwoven together.

29. The method of claim 27, wherein the layers are heat sealed together.

30. The method of claim 27, wherein a first one of the layers constitutes a rear panel of the airbag and a second one of the layers constitutes a rear panel of the airbag, the first and second layers being joined together over an extended seam width.

31. The method of claim 30, further comprising the steps of:
partitioning the airbag along partition lines into a plurality of chambers each receivable of the inflation fluid; and
determining the location of the partition lines to prevent concentration of stress in the seams.

32. The method of claim 31, wherein the step of determining the location of the partition lines comprises the step of analyzing the airbag using finite element analysis.
